(19) United States
(12) Patent Application Publication
(10) Pub. No.: US 2018/0324619 A1
(43) Pub. Date: Nov. 8, 2018

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Jing Wang, Beijing (CN); Liu Liu, Beijing (CN); Huiling Jiang, Beijing (CN)

(73) Assignee: NTT DOCOMO, INC., Tokyo (JP)

(21) Appl. No.: 15/772,867

(22) PCT Filed: Nov. 2, 2016
(86) PCT No.: PCT/JP2016/082503

§ 371 Date: May 2, 2018

(30) Foreign Application Priority Data
Nov. 5, 2015 (JP) 2015-218001

(51) Int. Cl. H04W 24/10; H04B 17/318; H04B 17/345; H04W 16/14; H04W 74/00

(52) U.S. Cl. CPC H04W 24/10; H04B 17/318; H04W 74/006; H04W 16/14; H04B 17/345

(57) ABSTRACT

The present invention is designed to carry out adequate inter-frequency measurements in future radio communication systems. According to one example of the present invention, a user terminal has a receiving section that receives first pattern information, which indicates the time length and the periodicity of a first gap period, and second pattern information, which indicates the time length and the periodicity of a second gap period, and a measurement section that measures inter-frequency received signal intensity in the first gap period that is configured based on the first pattern information, and measures inter-frequency reference signal received power and/or reference signal received quality in the second gap period that is configured based on the second pattern information

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, the specifications of LTE-A (also referred to as LTE-advanced, LTE Rel. 10, 11 or 12) have been drafted for further broadbandization and increased speed beyond LTE (also referred to as LTE Rel. 8 or 9), and successor systems of LTE (also referred to as, for example, FRA (Future Radio Access), 5G (5th generation mobile communication system), LTE Rel. 13 and so on) are under study.

The specifications of Rel. 8 to 12 LTE have been drafted assuming exclusive operations in frequency bands that are licensed to operators—that is, licensed bands. As licensed bands, for example, 800 MHz, 2 GHz, 1.7 GHz and 2 GHz are used.

In recent years, user traffic has been increasing steeply following the spread of high-performance user terminals (UE: User Equipment) such as smart-phones and tablets. Although more frequency bands need to be added to meet this increasing user traffic, licensed bands have limited spectra (licensed spectra).

Consequently, a study is in progress with Rel. 13 LTE to enhance the frequencies of LTE systems by using bands of unlicensed spectra (also referred to as “unlicensed bands”) that are available for use apart from licensed bands (see non-patent literature 2). For unlicensed bands, for example, the 2.4 GHz band and the 5 GHz band, where Wi-Fi (registered trademark) and Bluetooth (registered trademark) can be used, are under study for use.

To be more specific, with Rel. 13 LTE, a study is in progress to execute carrier aggregation (CA) between licensed bands and unlicensed bands. Communication that is carried out by using unlicensed bands with licensed bands like this is referred to as “LAA” (License-Assisted Access). Note that, in the future, dual connectivity (DC) between licensed bands and unlicensed bands and stand-alone in unlicensed bands may become the subject of study under LAA.

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2”
Non-Patent Literature 2: AT&T, Drivers, Benefits and Challenges for LTE in Unlicensed Spectrum, 3GPP TSG-RAN Meeting #62 RP-131701

### SUMMARY OF INVENTION

### Technical Problem

In future radio communication systems to implement LAA, user terminals are expected to support inter-frequency measurements for measuring at least one of the received signal intensity (for example, RSSI (Received Signal Strength Indicator), the reference signal received power (for example, RSRP (Reference Signal Received Power) and the reference signal received quality (for example, RSRQ (Reference Signal Received Quality), in cells (non-serving cells, non-serving carriers, etc.) that use different frequencies than the connecting unlicensed band cell (the serving cell, the serving carrier, etc.).

However, even if the techniques of inter-frequency measurements for licensed bands are applied to unlicensed bands on an as-is basis, there is a threat that inter-frequency measurements cannot be conducted adequately in non-serving cells of unlicensed bands.

The present invention has been made in view of the above, and it is therefore an object of the present invention to provide a user terminal, a radio base station and a radio communication method whereby inter-frequency measurements can be carried out adequately in future radio communication systems.

### Solution to Problem

According to one example of the present invention, a user terminal has a receiving section that receives first pattern information, which indicates the time length and the periodicity of a first gap period, and second pattern information, which indicates the time length and the periodicity of a second gap period, and a measurement section that measures inter-frequency received signal intensity in the first gap period that is configured based on the first pattern information, and measures inter-frequency reference signal received power and/or reference signal received quality in the second gap period that is configured based on the second pattern information.

### Advantageous Effects of Invention

According to the present invention, inter-frequency measurements can be carried out adequately in future radio communication systems.

### BRIEF DESCRIPTION OF DRAWINGS

FIG. 1 is a conceptual diagram of inter-frequency measurements in unlicensed bands;

FIGS. 2A and 2B are diagrams to show examples of measurement gaps in licensed bands;

FIG. 3 is a diagram to show examples of gap patterns according to example 1;

FIG. 4 is a conceptual diagram of inter-frequency measurements according to example 1;

FIGS. 5A and 5B are diagrams to show examples of inter-frequency measurement control according to example 1;

FIG. 6 is a diagram to explain examples in which measurement gaps block the receipt of the PDSCH and the transmission of the PUSCH;

FIG. 7 is a diagram to show examples of inter-frequency measurement control according to example 2.1;

FIG. 8 is a diagram to show examples of inter-frequency measurement control according to example 2.2;

FIG. 9 is a diagram to show examples of inter-frequency measurement control according to example 2.3;

FIG. 10 is a diagram to explain examples of collisions of RSRP/RSRQ and RSSI measurement gaps;

FIG. 11 is a diagram to show examples of inter-frequency measurement control according to example 3.1;

FIG. 12 is a diagram to show examples of inter-frequency measurement control according to example 3.2;

FIG. 13 is a diagram to show examples of inter-frequency measurement control according to example 3.3;

FIG. 14 is a diagram to show an example of a schematic structure of a radio communication system according to the present embodiment;

FIG. 15 is a diagram to show an example of an overall structure of a radio base station according to the present embodiment;

FIG. 16 is a diagram to show an example of a functional structure of a radio base station according to the present embodiment;

FIG. 17 is a diagram to show an example of an overall structure of a user terminal according to the present embodiment;

FIG. 18 is a diagram to show an example of a functional structure of a user terminal according to the present embodiment; and

FIG. 19 is a diagram to show an example hardware structure of a radio base station and a user terminal according to the present embodiment.

### DESCRIPTION OF EMBODIMENTS

In systems (for example, LAA systems) that run LTE/LTE-A in unlicensed bands, interference control functionality is likely to be necessary in order to allow co-presence with other operators' LTE, Wi-Fi, or other different systems. Note that, systems that run LTE/LTE-A in unlicensed bands may be collectively referred to as “LAA,” “LAA-LTE,” “LTE-U,” “U-LTE” and so on, regardless of whether the mode of operation is CA, DC or SA.

Generally speaking, when a transmission point (for example, a radio base station (eNB), a user terminal (UE) and so on) that communicates by using a carrier (which may also be referred to as a “carrier frequency,” or simply a “frequency”) of an unlicensed band detects another entity (for example, another user terminal) that is communicating in this unlicensed band carrier, the transmission point is disallowed to make transmission in this carrier.

So, the transmission point executes listening (LBT) at a timing that is a predetermined period ahead of a transmission timing. To be more specific, by executing LBT, the transmission point searches the whole of the target carrier band (for example, one component carrier (CC)) at a timing that is a predetermined period ahead of a transmission timing, and checks whether or not other devices (for example, radio base stations, user terminals, Wi-Fi devices and so on) are communicating in this carrier band.

Note that, in the present description, “listening” refers to the operation which a given transmission point (for example, a radio base station, a user terminal, etc.) performs before transmitting signals in order to check whether or not signals to exceed a predetermined level (for example, predetermined power) are being transmitted from other transmission points. Also, this “listening” performed by radio base stations and/or user terminals may be referred to as “LBT,” “CCA,” “carrier sensing” and so on.

If it is confirmed that no other devices are communicating, the transmission point carries out transmission using this carrier. If the received power measured during LBT (the received signal power during the LBT period) is equal to or lower than a predetermined threshold, the transmission point judges that the channel is in the idle state (LBT_{idle}), and carries out transmission. When a “channel is in the idle state,” this means that, in other words, the channel is not occupied by a specific system, and it is equally possible to say that a channel is “idle,” a channel is “clear,” a channel is “free,” and so on.

On the other hand, if only just a portion of the target carrier band is detected to be used by another device, the transmission point stops its transmission. For example, if the transmission point detects that the received power of a signal from another device entering this band exceeds a predetermined threshold, the transmission point judges that the channel is in the busy state (LBT_{busy}), and makes no transmission. In the event LBT_{busy} is yielded, LBT is carried out again with respect to this channel, and the channel becomes available for use only after it is confirmed that the channel is in the idle state. Note that the method of judging whether a channel is in the idle state/busy state based on LBT is by no means limited to this.

As LBT mechanisms (schemes), FBE (Frame Based Equipment) and LBE (Load Based Equipment) are currently under study. Differences between these include the frame configurations to use for transmission/receipt, the channel-occupying time, and so on. In FBE, the LBT-related transmitting/receiving configurations have fixed timings. Also, in LBE, the LBT-related transmitting/receiving configurations are not fixed in the time direction, and LBT is carried out on an as-needed basis.

To be more specific, FBE has a fixed frame cycle, and is a mechanism of carrying out transmission if the result of executing carrier sensing for a certain period (which may be referred to as “LBT duration” and so on) in a predetermined frame shows that a channel is available for use, and not making transmission but waiting until the next carrier sensing timing if no channel is available.

On the other hand, LBE refers to a mechanism for implementing the ECCA (Extended CCA) procedure of extending the duration of carrier sensing when the result of carrier sensing (initial CCA) shows that no channel is available for use, and continuing executing carrier sensing until a channel is available. In LBE, random backoff is required to adequately avoid contention.

Note that the duration of carrier sensing (also referred to as the “carrier sensing period”) refers to the time (for example, the duration of one symbol) it takes to gain one LBT result by performing listening and/or other processes and deciding whether or not a channel can be used.

A transmission point can transmit a predetermined signal (for example, a channel reservation signal) based on the result of LBT. Here, the result of LBT refers to information about the state of channel availability (for example, “LBT_{idle},” “LBT_{busy},” etc.), which is acquired by LBT in carriers where LBT is configured.

Also, when a transmission point starts transmission when the LBT result shows the idle state (LBT_{idle}), the transmission point can skip LBT and carry out transmission for a predetermined period (for example, for 10 to 13 ms). This transmission is also referred to as “burst transmission,” “burst” and so on.

As described above, by introducing interference control for use within the same frequency that is based on LBT mechanisms to transmission points in LAA systems, it is possible to prevent interference between LAA and Wi-Fi, interference between LAA systems and so on. Furthermore, even when transmission points are controlled independently per operator that runs an LAA system, it is possible to reduce interference without learning the details of each operator's control, by means of LBT.

Now, in LAA systems, to configure and/or reconfigure unlicensed band SCells (Secondary Cells) in user terminals, a user terminal has to detect SCells that are present in the surroundings by means of RRM (Radio Resource Management) measurements, measure their received quality, and then send a report to the network. RRM measurements in LAA are under study based on the discovery signal (DS) that is stipulated in Rel. 12.

Note that the signal for RRM measurements in LAA may be referred to as the “detection/measurement signal,” the “discovery reference signal” (DRS), the “discovery signal” (DS), the “LAA DRS,” the “LAA DS,” and so on. Also, an unlicensed band SCell may be referred to as, for example, an LAA SCell.

Similar to the Rel. 12 DS, the LAA DRS may be constituted by including at least one of a synchronization signal (PSS (Primary Synchronization Signal) and/or the SSS (Secondary Synchronization Signal)), a cell-specific reference signal (CRS) and a channel state information reference signal (CSI-RS) and so on.

Also, the network (for example, radio base stations) can configure the DMTC (Discovery Measurement Timing Configuration) of the LAA DRS in user terminals per frequency. The DMTC contains information about the transmission cycle of the DRS (which may be also referred to as “DMTC periodicity” and so on), the offset of DRS measurement timings, and so on.

The DRS is transmitted per DMTC periodicity, in the DMTC duration. Here, according to Rel. 12, the DMTC duration is fixed to 6 ms. Also, the length of the DRS (which may be also referred to as the “DRS occasion,” the “DS occasion,” the “DRS burst,” the “DS burst” and so on) that is transmitted in the DMTC duration is between 1 ms and 5 ms. The LAA DS may be configured the same as in Rel. 12, or may be configured differently. For example, taking the time of LBT into account, the DRS occasion may be made 1 ms or shorter, or may be made 1 ms or greater.

In an unlicensed band cell, a radio base station executes listening (LBT) before transmitting the LAA DRS, and transmits the LAA DRS when LBT_{idle} is yielded. A user terminal learns the timings and the periodicity of DRS occasions based on the DMTC reported from the network, and detects and/or measures the LAA DRS.

Now, in LAA, a study is in progress to enable a user terminal to support inter-frequency measurements to carry out measurements in non-serving carriers (unlicensed bands) that are apart from the connecting serving carrier (unlicensed band). In inter-frequency measurements, at least one of the reference signal received power (for example, RSRP (Reference Signal Received Power), the received signal intensity (for example, RSSI (Received Signal Strength Indicator) and the reference signal received quality (for example, RSRQ (Reference Signal Received Quality) is measured in non-serving carriers.

Here, the reference signal received power refers to the desired signal's received power, which is measured by using, for example, the CRS, the DRS and so on. Also, the received signal intensity refers to the total received power combining the desired signal's received power and the power of interference and noise. The reference signal received quality refers to the ratio of the reference signal received power to the received signal intensity. Although examples to use RSRP as the reference signal received power, RSSI as the received signal intensity and RSRQ as the reference signal received quality will be described in the following description, these are by no means limiting.

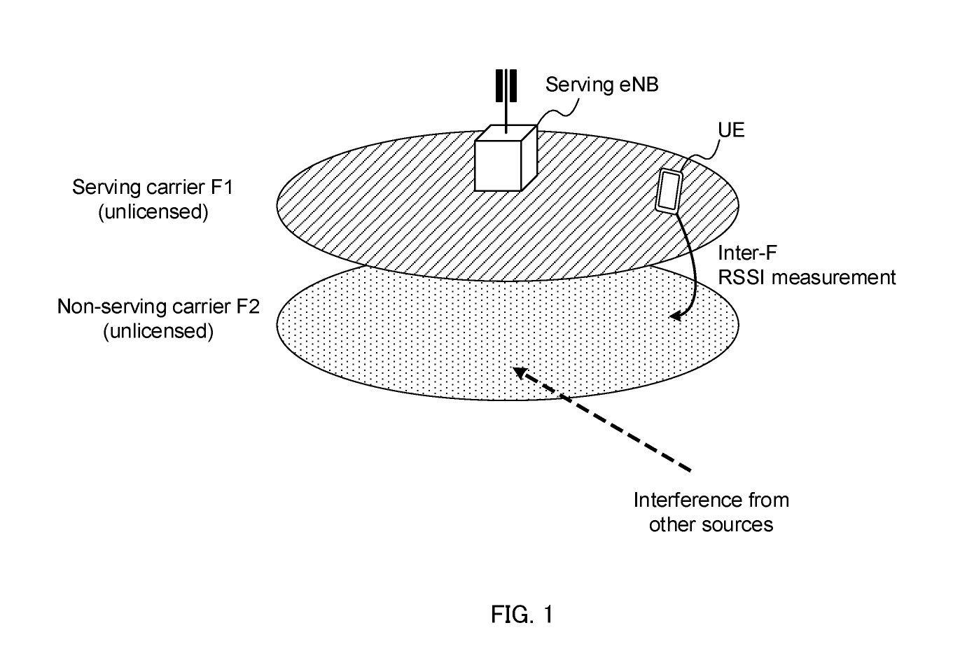

FIG. 1 is a conceptual diagram of inter-frequency measurements in unlicensed bands. For example, referring to FIG. 1, the radio base station (serving eNB) is configured to be capable of communicating by using carriers (also referred to as “component carriers,” “cells,” etc.) F1 and F2 of varying frequencies in unlicensed bands. Although the user terminal (UE) is connected with the radio base station by using carrier F1 (“serving carrier,” “serving cell,” etc.), the user terminal is not connected with the radio base station by using carrier F2 (“non-serving carrier,” “non-serving cell,” etc.).

In the case shown in FIG. 1, the user terminal switches the receiving frequency from carrier F1 to carrier F2 in measurement gaps, measures at least one of RSRP, RSSI and RSRQ, by using the DRS transmitted in carrier F2.

Here, a measurement gap refers to a period for carrying out inter-frequency measurements, and, in this period, the user terminal stops receiving in the communicating carrier, and conducts measurements in carriers of other frequencies. A predetermined duration of time (hereinafter referred to as the “measurement gap length” (MGL)) is repeated in a predetermined periodicity (hereinafter referred to as the “measurement gap repetition period” (MGRP)), and the user terminal uses these as measurement gaps. The gap pattern is determined by MGL and MGRP.

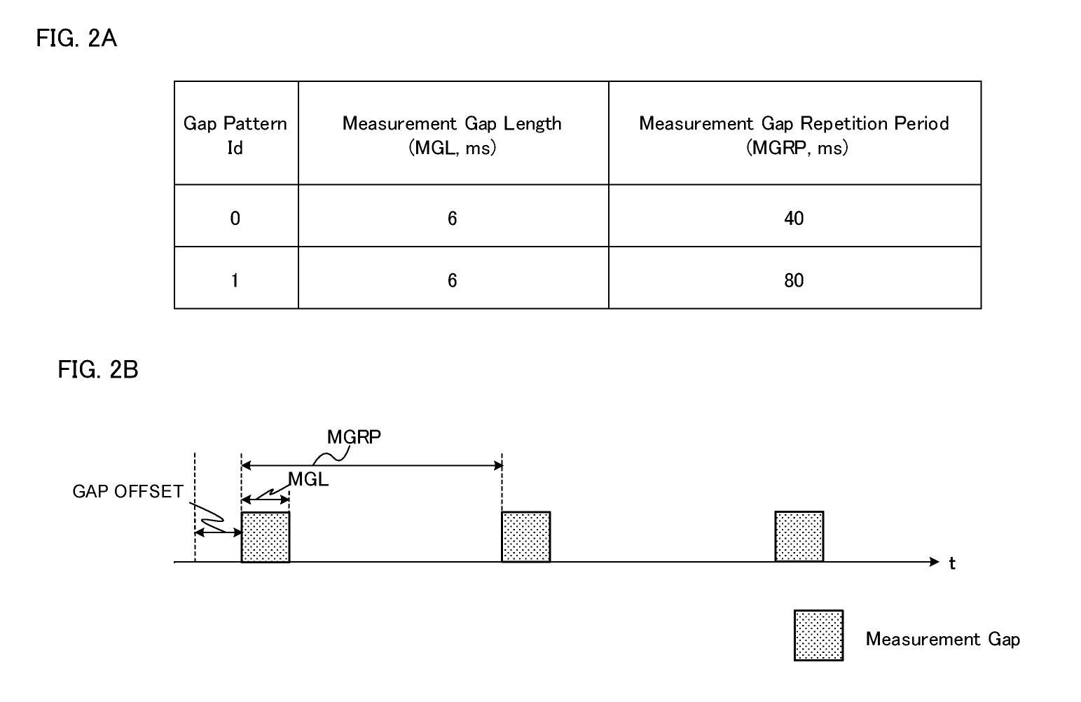

FIG. 2 provide diagrams to show examples of existing gap patterns. For example, in FIG. 2A, gap pattern 0, in which MGL is 6 ms and MGRP is 40 ms, and gap pattern 1, in which MGL is 6 ms and MGRP is 80 ms, are defined.

Also, in inter-frequency measurements, the gap offset is reported via RRC signaling. Here, as shown in FIG. 2B, the gap offset refers to the start offset from the top of a radio frame to the beginning of a measurement gap, and indicates the timing of the measurement gap. The user terminal may specify the gap pattern (see FIG. 2A) based on the gap offset that is reported. In this case, the gap patterns in FIG. 2A are reported implicitly.

Referring to FIG. 2B, in measurement gaps, which have an MGL (for example, 6 ms) and which are repeated in an MGRP (for example, 40 or 80 ms), the user terminal of FIG. 1 stops receiving in carrier F1 and measures at least one of RSRP, RSSI and RSRQ, in carrier F2.

However, if the existing gap patterns shown in FIG. 2A are applied to future radio communication systems that implement LAA on an as-is basis, there is a threat that adequate inter-frequency RSSI and/or RSRP measurements are not possible in unlicensed bands.

For example, in inter-frequency measurements in licensed bands, at least one of RSRP, RSSI and RSRQ is measured in a plurality of carriers of different frequencies, by using measurement gaps of a single structure (for example, one of gap patterns 0 and 1 in FIG. 2A). That is, when inter-frequency measurements are carried out in licensed bands, RSRP, RSSI and RSRQ can be measured only in the same carrier. On the other hand, when inter-frequency measurements are conducted in unlicensed bands, cases might occur where a carrier to request RSSI measurement and a carrier to request RSRP measurement are present.

For example, a radio base station may request that a user terminal measure RSSI in carriers (cells) that do not transmit the DRS and/or data (hereinafter referred to as “DRS/data”). This is because a carrier (cell) may be selected based on the load and/or interference (hereinafter referred to as “load/interference”) that is estimated from the RSSIs of these carriers. Meanwhile, since DRSs are not transmitted in these carriers, DRS-based RSRP measurements need not be carried out.

Also, in inter-frequency measurements in licensed bands, MGL is defined to be 6 ms, so that the PSS and the SSS, which are arranged in 5-ms periodicity, can be detected. The 6-ms MGL is effective even in RSRP is measured by using DRSs in unlicensed bands. This is because, although the location of a DRS depends upon listening in unlicensed bands, a DRS may be arranged in one of the subframes in DMTC (6 ms). In this case, the DRS occasion may be shorter than 1 ms.

Meanwhile, a 6-ms MGL may be unsuitable for RSSI measurements in unlicensed bands. In unlicensed bands, the time it takes to measure the RSSI reported from a single user terminal is minimum one OFDM symbol, and may be made maximum 5 ms, which is under study. Consequently, a significant amount of time, in which RSSI is not measured, is included in measurement gaps, and the user terminal faces the threat of losing the opportunities to communicate in the connecting cell (serving carrier).

Also, in comparison with carrier aggregation in existing systems (for example, Rel. 12), in LAA, an increased number of carriers may have to conduct inter-frequency measurements in licensed bands. Consequently, when measurement gaps are configured in periodicity of 40 ms or 80 ms based on gap pattern 0 or 1 shown in FIG. 2A, there is a threat that it takes a longer time to measure RSSI in many carries, and, as a result of this, carrier (cell) selection is delayed.

As described above, if, in inter-frequency measurements in unlicensed bands, measurement gaps of a single structure are used in the same way as in licensed-band inter-frequency measurements, there is a threat the desired carrier's RSRP and RSSI cannot be measured flexibly, and efficient inter-frequency measurements cannot be carried out. Also, if inter-frequency RSSI measurements are carried out in unlicensed bands by using existing gap patterns (FIG. 2A), this, too, has a threat of lowering the spectral efficiency, because a large amount of non-measurement time is included in the measurement gaps.

So, the present inventors have come up with the idea of making it possible to measure the RSRP and the RSSI of every different carrier and making inter-frequency measurements in unlicensed bands efficient, by configuring the gaps for measuring RSRP and/or RSRQ (hereinafter referred to as “RSRP/RSRQ”) and the gaps for measuring RSSI separately. Also, the present inventors have come up with the idea of improving the spectral efficiency upon inter-frequency RSSI measurements in unlicensed bands by defining gap patterns having shorter lengths in time and/or periodicities than existing gap patterns.

Now, an embodiment of the present invention will be described below in detail with reference to the accompanying drawings. Although the following embodiment will be described assuming that a carrier (cell) where listening is configured is an unlicensed band, this is by no means limiting. The present embodiment is applicable to any carriers (or cells) in which listening is configured, regardless of whether this carrier is a licensed band or an unlicensed band.

Also, although a case will be assumed with the present embodiment where CA or DC is applied between a carrier in which listening is not configured (for example, the primary cell (PCell) of a licensed band) and a carrier in which listening is configured (for example, a secondary cell (SCell) of an unlicensed band), this is by no means limiting. For example, the present embodiment is applicable to cases where a user terminal connects with a carrier (cell) in which listening is configured in stand-alone.

In the present embodiment, a user terminal receives first pattern information, which represents the MGL (time length) and the MGRP (periodicity) of the measurement gap for RSSI (first gap period), and second pattern information, which represents the MGL and the MGRP of the measurement gap for RSRP/RSRQ (second gap period). Also, the user terminal carries out inter-frequency RSSI measurements in RSSI measurement gaps configured based on the first pattern information, and carries out inter-frequency RSRP/RSRQ measurements in RSRP/RSRQ measurement gaps configured based on the second patter n information.

Although the first and second pattern information according to the present embodiment refers to, for example, gap pattern IDs, gap offsets that correspond to gap patterns and so on, any information may be used as long as the information represents MGL and MGRP. Also, a user terminal may receive the first pattern information and the second pattern information from a radio base station via higher layer signaling such as RRC (Radio Resource Control) signaling or broadcast information.

### Example 1

The gap patterns of RSSI measurement gaps will be described with example 1. In example 1, the MGL and/or the MGRP of RSSI measurement gaps are shorter than the MGL and/or the MGRP of RSRP/RSRQ measurement gaps.

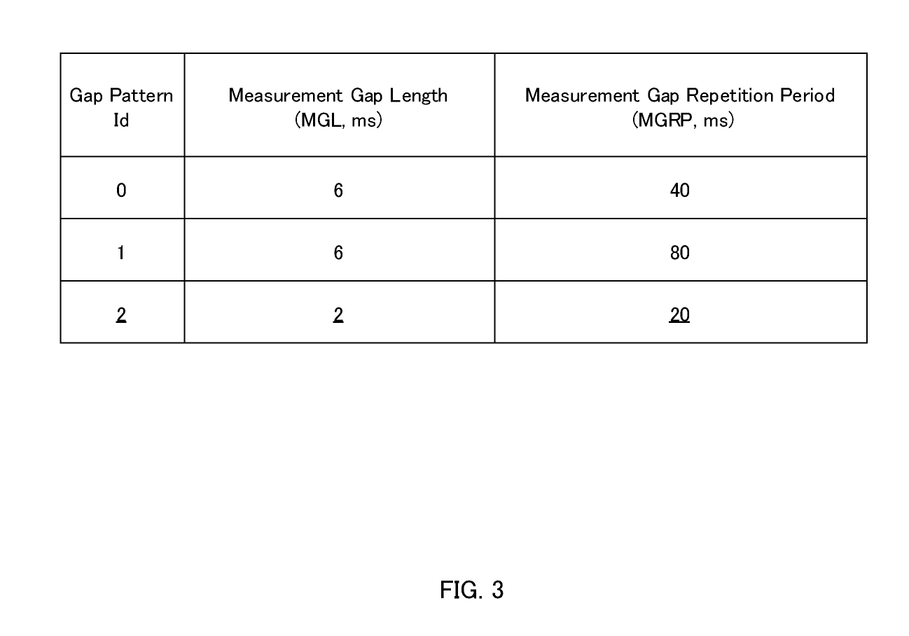

FIG. 3 is a diagram to show examples of gap patterns for use in example 1. In FIG. 3, gap pattern 2 is defined as the configuration of RSSI measurement gaps. In gap pattern 2, the MGL is configured shorter than the MGL (6 ms) of existing gap pattern 0 and 1. Also, the MGRP is configured shorter than the MGRP (40 ms) of existing gap pattern 0.

The MGL in gap pattern 2 may be configured depending on the time it takes to measure RSSI in licensed bands. As mentioned earlier, since it takes minimum one OFDM symbol of time to measure RSSI, the MGL may be configured to include the time required to measure RSSI. Although, in FIG. 3, the MGL of gap pattern 2 is configured to 2 ms, this is simply an example and by no means limiting. The MGL of gap pattern 2 is by no means limited to this as long as it is one OFDM symbol or longer, and shorter than 6 ms.

Also, the MGRP in gap pattern 2 is configured shorter than 40 ms so as to make it possible to measure RSSI in many carriers of varying frequencies in a short time. Although, in FIG. 3, the MGL of gap pattern 2 is configured to 20 ms, this is simply an example and by no means limiting.

In example 1, a radio base station transmits the first pattern information, which represents gap pattern 2 of FIG. 3, as the gap pattern for RSSI in a user terminal. Meanwhile, the radio base station transmits the second pattern information, which represents gap pattern 0 or 1 of FIG. 3, to the user terminal, as the gap pattern for RSRP/RSRQ. The user terminal configures RSRP/RSRQ measurement gaps and RSSI measurement gaps, in accordance with the gap patterns represented by the first and the second pattern information from the radio base station.

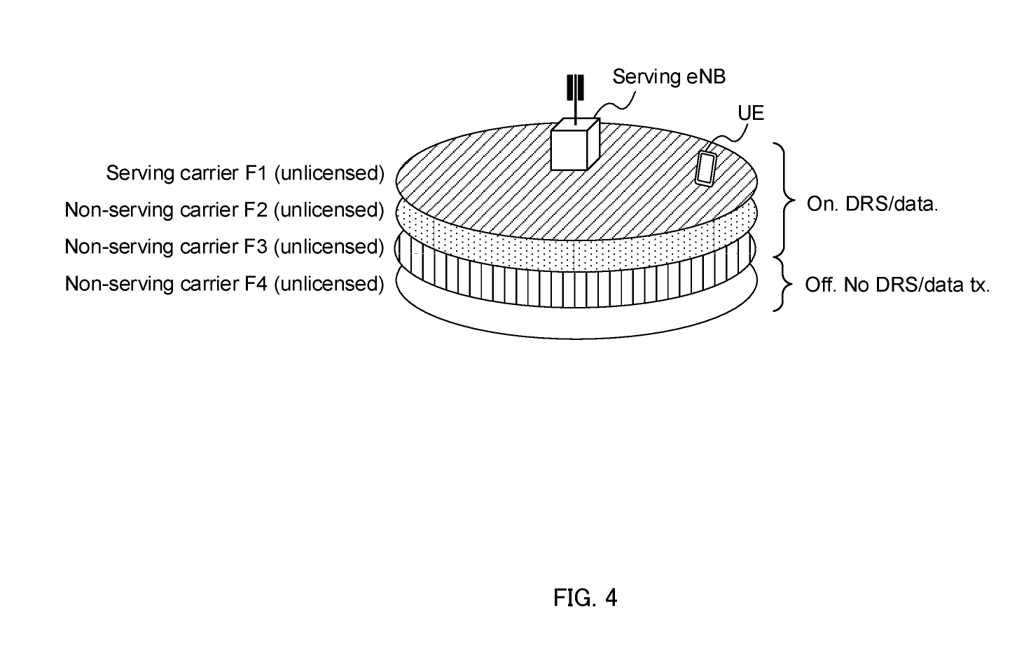

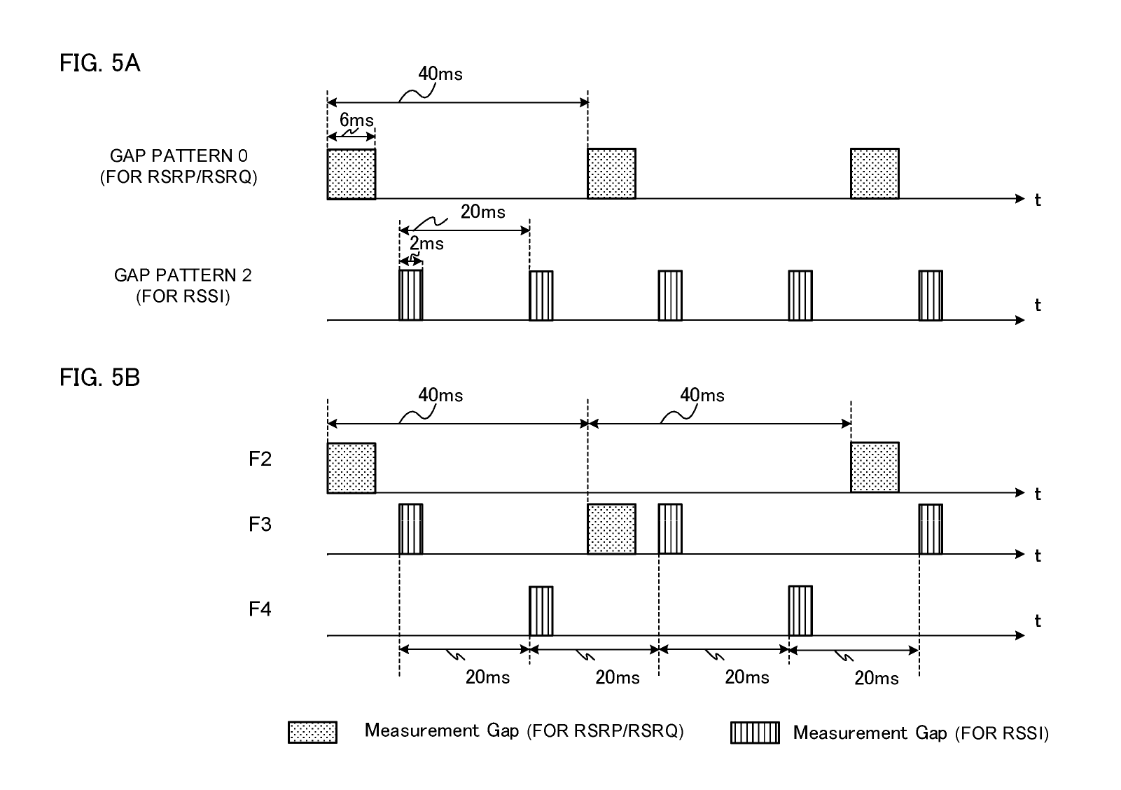

Now, inter-frequency measurements according to example 1 will be described below in detail with reference to FIGS. 4 and 5. FIG. 4 is a diagram to show an example of inter-frequency measurements according to example 1. FIG. 5 is a diagram to show an example of inter-frequency measurement control according to example 1.

For example, referring to FIG. 4, the radio base station (serving eNB) is configured to be capable of communicating by using varying carriers (“component carriers,” “cells,” etc.) F1 to F4 in unlicensed bands. The user terminal (UE) is connected with the radio base station by using carrier F1, but is not connected with the radio base station by using carriers F2 to F4. Also, carriers F1 to F3 are in the on state, in which DRS/data are transmitted and received. Meanwhile, carrier F4 is in the off state, in which DRS/data are not transmitted and received.

In FIG. 4, the radio base station transmits the first pattern information, which represents gap pattern 2 as the configuration of RSSI measurement gaps, to the user terminal. The radio base station transmits the second pattern information, which represents gap pattern 0 as the configuration of RSRP/RSRQ measurement gaps. Also, in FIG. 4, the radio base station transmits measurement command information that commands the user terminal to measure RSRP in carriers F2 and F3, and measure RSSI in carriers F3 and F4.

As shown in FIG. 5A, the user terminal configures RSSI measurement gaps based on gap pattern 2 (MGL=2 ms and MGRP=20 ms), represented by the first pattern information. Also, the user terminal configures RSRP/RSRQ measurement gaps based on gap pattern 0 (MGL=6 ms and MGRP=40 ms), represented by the second pattern information.

Also, as shown in FIG. 5B, the user terminal measures RSSI in carrier F3 and carrier F4, alternately, in RSSI measurement gaps. Also, the user terminal measures RSRP in carrier F2 and carrier F3, alternately, in RSRP/RSRQ measurement gaps.

In example 1, the MGL (for example, 2 ms) of RSSI measurement gaps is configured shorter than the MGL (6 ms) of existing gap patterns 0 and 1. Consequently, even when the time to be required for RSSI measurements is configured short (for example, minimum one OFDM symbol), it is possible to prevent a large amount of time, in which RSSI is no measured, from being included in the measurement gaps, and avoid losing the opportunities for communicating in carrier F1.

Also, in example 1, the MGRP (for example, 20 ms) of RSSI measurement gaps is configured shorter than the MGRP (40 ms) of existing gap pattern 0. Consequently, even when the number of carriers to require measurements increases, it is still possible to reduce the time it takes to measure the RSSIs of these carriers.

For example, referring to FIG. 5B, when existing gap pattern 0 is used, it takes 46 (=40+6) ms to measure the RSSIs of two carriers F3 and F4. Meanwhile, if new gap pattern 2 is used, the time it takes to measure the RSSIs of two carriers F3 and F4 is shortened to 22 (=20+2) ms. Consequently, even when RSSI has to be measured in many carriers, it is still possible to prevent the delay of carrier (cell) selection.

Also, in example 1, as shown in FIG. 5A, RSSI measurement gaps are configured apart from RSRP/RSRQ measurement gaps. Consequently, as shown in FIG. 5B, even when the carriers that require RSRP measurements (for example, F2 and F3) and the carriers that require RSSI measurements (for example, F3 and F4) are different, it is still possible to conduct inter-frequency measurements in a flexible fashion.

Note that, although, in FIGS. 5A and 5B, existing gap pattern 0 is used for the RSRP/RSRQ gap pattern, this is by no means limiting. It is equally possible to use existing gap pattern 1 for the RSRP/RSRQ gap pattern.

### Example 2

When, in existing systems (for example, Rel. 12), the receipt of a downlink shared channel (PDSCH: Physical Downlink Shared Channel) or the transmission of an uplink shared channel (PUSCH: Physical Uplink Shared Channel) that is scheduled in a user terminal collides with a measurement gap, the measurement in the measurement gap is prioritized.

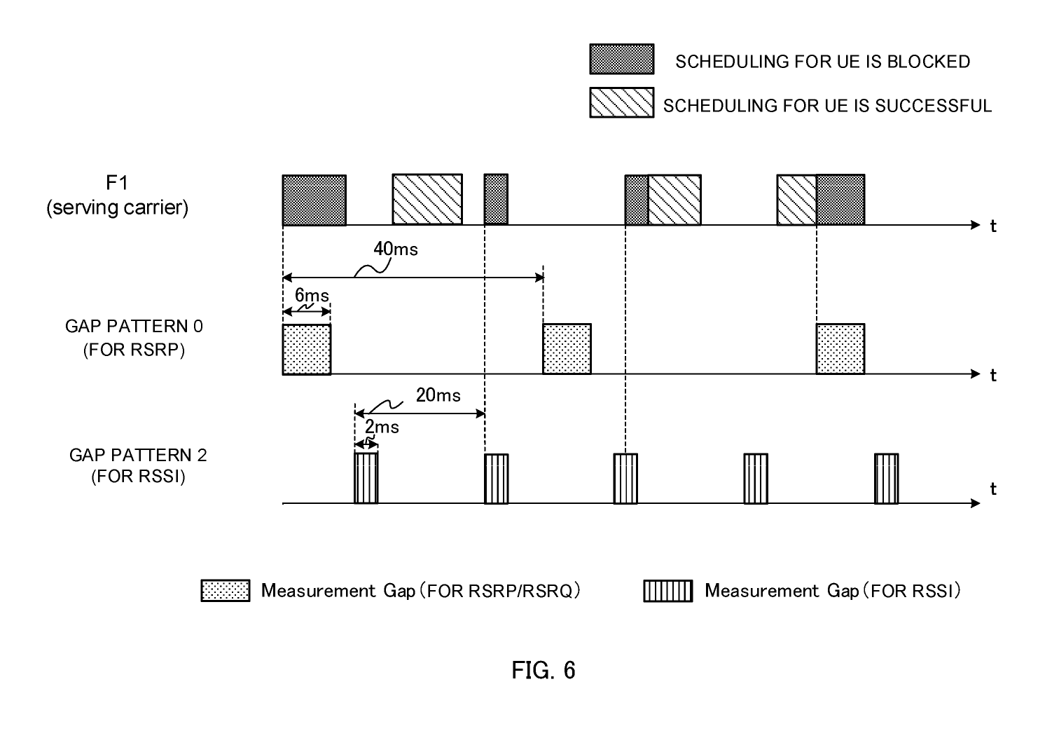

Meanwhile, as has been described with example 1, when RSSI measurement gaps and RSRP/RSRQ measurement gaps are configured, as shown in FIG. 6, for example, the RSSI or RSRP/RSRQ measurement gaps have a threat of interfering with the receipt of the PDSCH or the transmission of the PUSCH scheduled in the user terminal (alternatively, PDSCH/PUSCH scheduling opportunities). For example, in FIG. 6, the first and third measurement gaps for RSRP/RSRQ from the left and the second and third measurement gaps for RSSI from the left interfere with the receipt of the PDSCH or the transmission of the PUSCH scheduled for the user terminal.

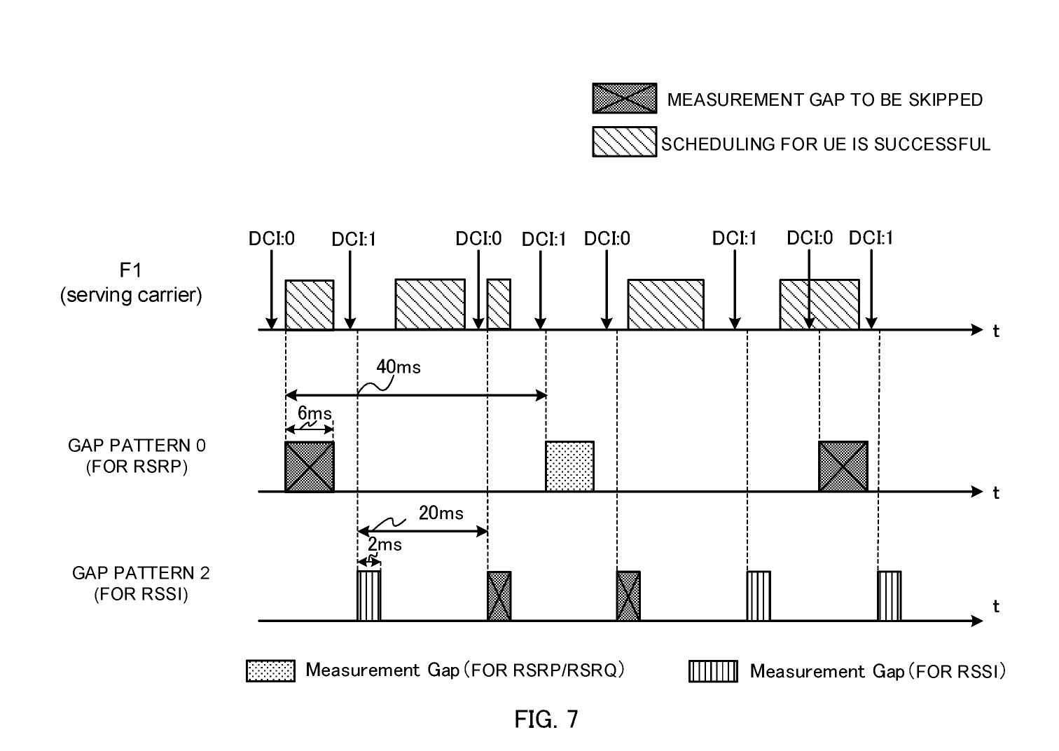

So, according to example 2, the measurements in RSSI measurement gaps and/or RSRP/RSRQ measurement gaps can be stopped (skipped) so as not to interfere with the receipt of the PDSCH or the transmission of the PUSCH scheduled (allocated) in the user terminal. The first to third examples of inter-frequency measurement control according to example 2 (examples 2.1 to 2.3) will be described below with reference to FIGS. 7 to 9.

### Example 2.1

FIG. 7 is a diagram to show an example of inter-frequency measurement control according to example 2.1. In example 2.1, a user terminal decides whether or not to carry out (or skip) the measurement in each measurement gap based on command information related to measurement gaps from a radio base station. Here, the command information related to measurement gaps is, for example, information to indicate whether or not each measurement gap is valid, but this is by no means limiting. This command information may be any information as long as whether or not to carry out (or skip) measurements in measurement gaps can be judged based on this information.

Also, existing downlink control information (DCI) bits may be re-used in this command information, or new bits may be set forth. For example, it is possible to indicate that a measurement gap is valid if the command information is “1,” and indicate that a measurement gap is invalid if the command information is “0,” but this is by no means limiting.

As shown in FIG. 7, the radio base station transmits DCI to include the above command information in a subframe that is a predetermined number of subframes (for example, one subframe) before each RSSI and RSRP/RSRQ measurement gap. Note that, in FIG. 7, the radio base station transmits DCI that includes the above-described command information by using the user terminal' serving carrier in an unlicensed band, this is by no means limiting. This DCI to include the command information may be transmitted in at least one of a licensed carrier and an unlicensed carrier.

The user terminal receives the DCI to include the above command information from the radio base station, and, based on this command information, decides whether or not carry out (or skip) the measurement in the nearest RSSI or RSRP/RSRQ measurement gap.

For example, in FIG. 7, in the first and third measurement gaps for RSRP/RSRQ from the left, the PDSCH/PUSCH are scheduled for the user terminal in the serving carrier. Consequently, in the subframes that are a predetermined number of subframes before these first and third measurement gaps, the radio base station transmits DCI, which includes the command information (“0”) to indicate that these measurement gaps are invalid. Based on this command information, the user terminal stops (skips) the RSRP/RSRQ measurements in the first and third measurement gaps.

Meanwhile, in the second measurement gap for RSRP/RSRQ from the left, the PDSCH/PUSCH are not scheduled for the user terminal in the serving carrier. Consequently, in the subframe that is a predetermined number of subframes before the second measurement gap, the radio base station transmits DCI, which includes the command information (“1”) to indicate that this measurement gap is valid. Based on this command information, the user terminal carries out (does not skip) the RSRP/RSRQ measurements in the second measurement gap.

Similarly, in FIG. 7, in the second and third measurement gaps for RSSI from the left, the PDSCH/PUSCH are scheduled for the user terminal in the serving carrier. Consequently, in the subframes that are a predetermined number of subframes before these second and third measurement gaps, the radio base station transmits DCI, which includes the command information (“0”) to indicate that these measurement gaps are invalid. Based on this command information, the user terminal stops (skips) the RSSI measurements in the second and third measurement gaps.

Meanwhile, in the first, fourth and fifth measurement gaps for RSSI from the left, the PDSCH/PUSCH are not scheduled for the user terminal in the serving carrier. Consequently, in the subframes that are a predetermined number of subframes before these first, fourth and fifth measurement gaps, the radio base station transmits DCI, which includes the command information (“1”) to indicate that these measurement gaps are valid. Based on this command information, the user terminal carries out (does not skip) the RSSI measurements in these first, fourth and fifth measurement gaps.

Although, in FIG. 7, whether or not to carry out (or skip) measurements is controlled based on the above-described command information in both RSSI measurement gaps and RSRP/RSRQ measurement gaps, this is by no means limiting. For example, it is equally possible to control whether or not to carry out (or skip) measurements based on the above command information only in RSSI measurement gaps. In this case, as for the RSRP/RSRQ measurement gaps, these measurement gaps may be prioritized over the scheduling of the PDSCH/PUSCH, as in existing systems (that is, the measurement gaps need not be skipped).

### Example 2.2

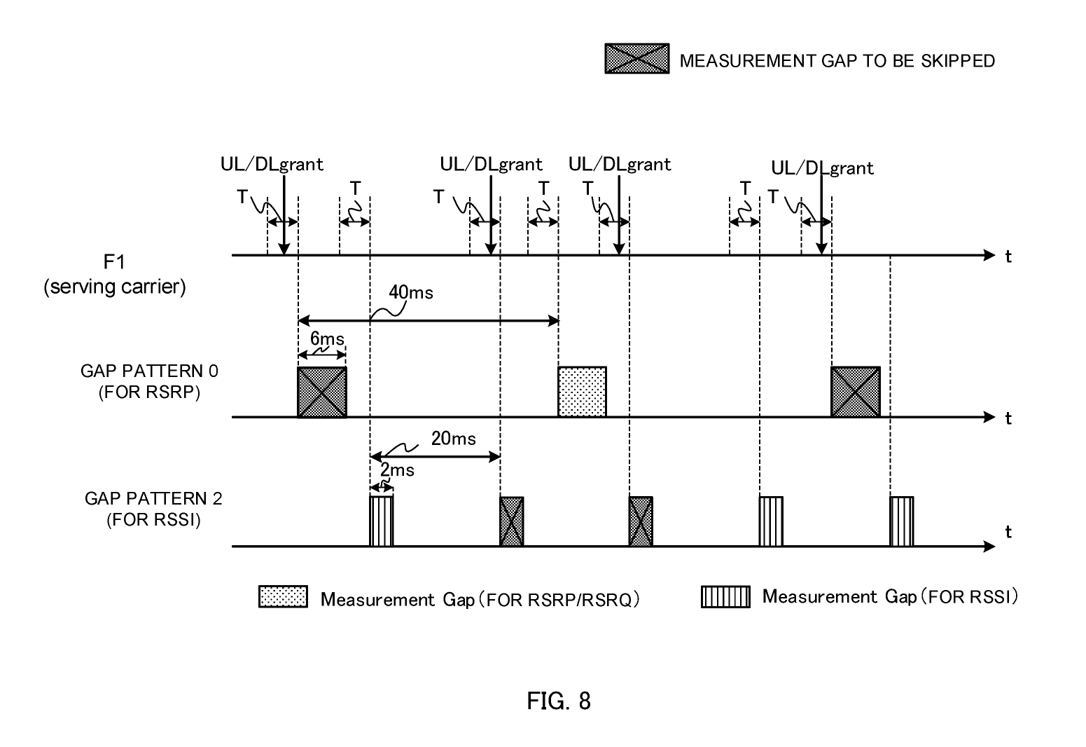

FIG. 8 is a diagram to show an example of inter-frequency measurement control according to example 2.2. In example 2.2, a user terminal controls the measurement in each measurement gap based on whether or not PDSCH/PUSCH scheduling information is received within a predetermined period before each measurement gap. The scheduling information here information that indicates the allocation of the PDSCH/PUSCH to the user terminal, and may be referred to as a downlink (DL) assignment, a downlink (DL) grant, an uplink (UL) grant and so on. This scheduling information is included in DCI.

As shown in FIG. 8, when the PDSCH/PUSCH are scheduled for the user terminal in the serving carrier, the radio base station transmits scheduling information, which shows the result of scheduling result, to the user terminal. Note that, although, in FIG. 8, the scheduling information is transmitted by using the user terminal's serving carrier in an unlicensed band, this is by no means limiting. The scheduling information has only to be transmitted by using at least one of a licensed carrier and an unlicensed carrier.

When the above scheduling information is received within a predetermined period before each measurement gap, the user terminal stops (skips) the measurement in each measurement gap, and, if no scheduling information is received in this predetermined period, the user terminal carries out the measurement in each measurement gap.

For example, in FIG. 8, the user terminal receives scheduling information (UL/DL grant) within a predetermined period T before the first and third measurement gaps for RSRP/RSRQ from the left. Consequently, the user terminal stops (skips) the RSRP/RSRQ measurements in the first and third measurement gaps. On the other hand, the user terminal receives no scheduling information within a predetermined period T before the second measurement gap for RSRP/RSRQ from the left. Consequently, the user terminal measures RSRP/RSRQ in this second measurement gap.

Similarly, in FIG. 8, the user terminal receives scheduling information (UL/DL grant) within a predetermined period T before the second and third measurement gaps for RSSI from the left. Consequently, the user terminal stops (skips) the RSSI measurements in the second and third measurement gaps. On the other hand, the user terminal receives no scheduling information within a predetermined period T before the first, fourth and fifth measurement gaps for RSSI from the left. Consequently, the user terminal measures RSSI in the first, fourth and fifth measurement gaps.

Although, in FIG. 8, whether or not to carry out (or skip) measurements is controlled, in both RSSI measurement gaps and RSRP/RSRQ measurement gaps, based on the timing the above-described scheduling information is received, this is by no means limiting. For example, it is equally possible to control whether or not to carry out (or skip) measurements based on the timing to receive the above scheduling information only in RSSI measurement gaps. In this case, as for the RSRP/RSRQ measurement gaps, these measurement gaps may be prioritized over the scheduling of the PDSCH/PUSCH, as in existing systems (that is, the measurement gaps need not be skipped).

### Example 2.3

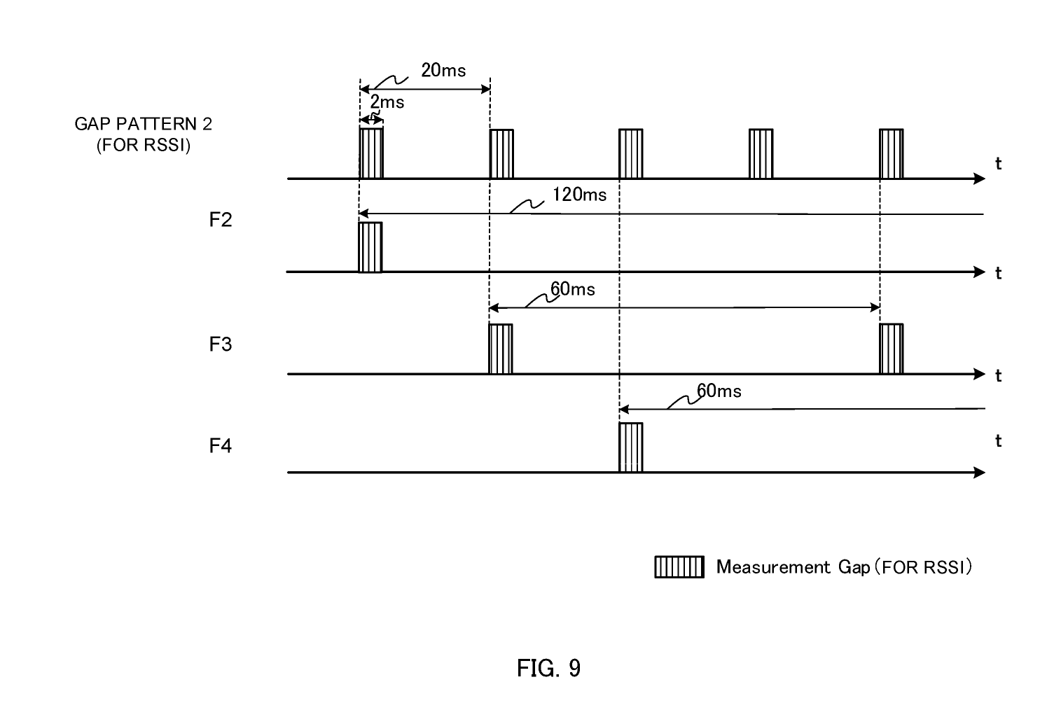

FIG. 9 is a diagram to show an example of inter-frequency measurement control according to example 2.3. In example 2.3, the user terminal may measure RSSI in a different periodicity, per carrier, in RSSI measurement gaps. Note that, although not illustrated, the user terminal may measure RSRP/RSRQ in a different periodicity, per carrier, in RSRP/RSRQ measurement gaps.

In example 2.3, the user terminal determines the measurement periodicity for each carrier, in RSSI (or RSRP/RSRQ) measurement gaps, based on carrier-specific control information from the radio base station. The carrier-specific control information here may include each inter-frequency measurement target carrier's measurement periodicity itself, or may include parameters to use to calculate the measurement periodicity. The carrier-specific control information is reported from the radio base station to the user terminal by using, for example, higher layer signaling such as RRC signaling, broadcast information and so on.

For example, in FIG. 9, the user terminal configures RSSI measurement gaps in a 20-ms periodicity based on gap pattern 2 (FIG. 3). In this case, the user terminal configures the RSSI measurement periodicities in carriers F2, F3 and F4 to 120 ms, 60 ms and 60 ms, respectively, based on periodicity information from the radio base station. In this case, in the fifth RSSI measurement gap from the left, the RSSIs of carriers F2 to F4 are not measured. Consequently, the measurement gap can be used for PDSCH/PUSCH scheduling.

According to example 2 (examples 2.1 to 2.3), the measurements in RSSI measurement gaps and/or RSRP/RSRQ measurement gaps are stopped (skipped) so as not to lose the opportunities for scheduling the PDSCH/PUSCH (or not to interfere with the receipt of the PDSCH/the transmission of the PUSCH scheduled). Consequently, it is possible to prevent measurement gaps from interfering with the receipt of the PDSCH or the transmission of the PUSCH that is scheduled in a user terminal (or PDSCH/PUSCH scheduling opportunities), and lowering the throughput.

Note that, when, in example 2, gap pattern 2 to have a shorter MGRP than existing gap patterns 0 and 1 is used, the likelihood that measurement opportunities for a skipped carrier come earlier than in existing gap patterns 0 and 1. Consequently, while it is possible to apply existing gap patterns 0 and 1 to RSSI measurements in example 2, from the perspective of enabling quick carrier (cell) selection, it is preferable to apply gap pattern 2 that has been described with example 1.

### Example 3

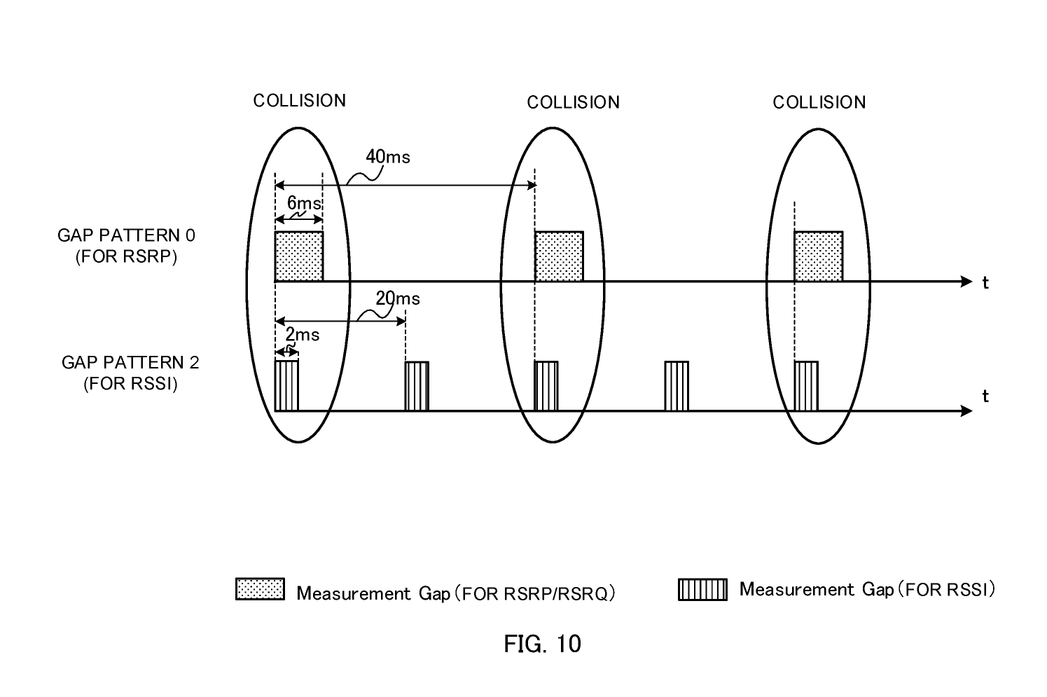

As has been described with example 1, when RSSI measurement gaps and RSRP/RSRQ measurement gaps are configured, for example, as shown in FIG. 10A, there is a threat that the RSSI measurement gaps and the RSRP/RSRQ measurement gaps collide with each other. On the radio base station end, it may not be possible to avoid such collisions. So, with example 3, the way a user terminal operates when an RSSI measurement gap and an RSRP/RSRQ measurement gap collide with each other in time will be described.

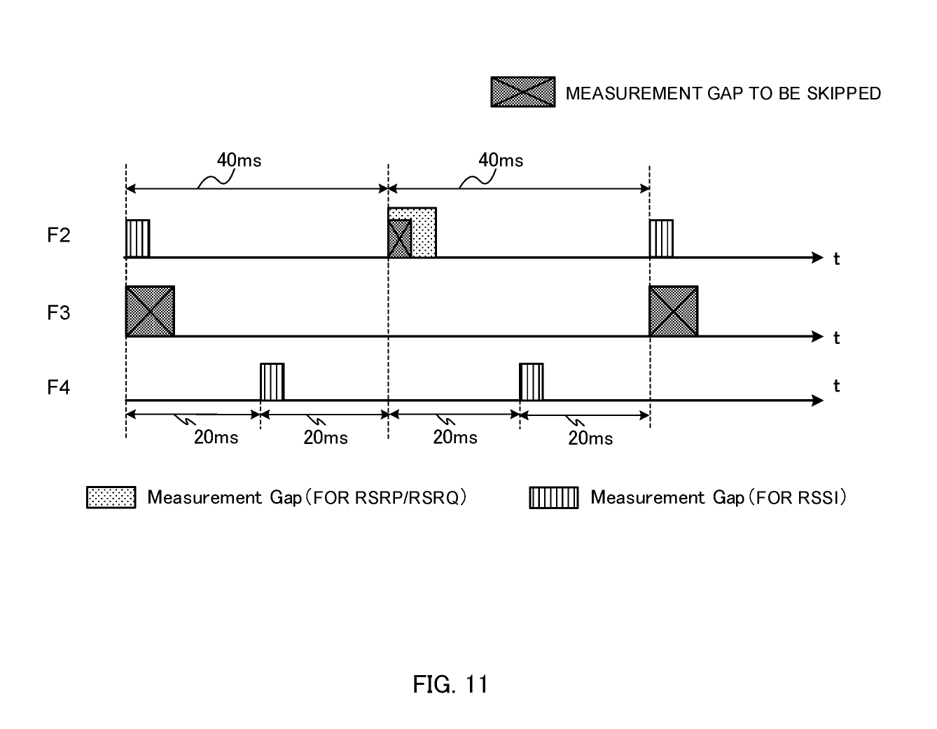

With example 3, in order to prevent an RSSI measurement gap and an RSRP/RSRQ measurement gap from colliding, one of the measurement gaps is prioritized. Now, the first to third examples of inter-frequency measurement control according to example 3 (examples 3.1 to 3.3) will be described with reference to FIGS. 11 to 13.

Note that examples will be described with FIGS. 11 to 13 where a user terminal that serves carrier F1 as the serving carrier in an unlicensed band measures the RSSIs of carriers F2 and F4 in RSSI measurement gaps, and measures the RSRPs/RSRQs of carriers F2 and F3 in RSRP/RSRQ measurement gaps.

Also, examples will be described with FIGS. 11 to 13 where the MGRP for RSRP/RSRQ is 40 ms and the MGRP for RSSI is 20 ms. As shown in FIGS. 11 to 13, when the RSRP/RSRQ measurement gap of a 40-ms periodicity and the RSSI measurement gap of a 20-ms periodicity start at the same timing, the RSRP/RSRQ measurement gap always collides with the RSSI measurement gap.

### Example 3.1

FIG. 11 is a diagram to shown an example of inter-frequency measurement control according to example 3.1. In example 3.1, when the RSRP/RSRQ measurement gap and the RSSI measurement gap collide with each other, the user terminal decides which measurement gap should be prioritized based on the indices of carriers that are measured in these measurement gaps and based on the information that is measured (the type of measurements).

To be more specific, in example 3.1, the user terminal may prioritize the measurement gap in which the carrier to be measured has the lower index. Also, if the carriers that are subject to measurements have equal indices, the user terminal decides the measurement gap to prioritize based on the information that is measured. To be more specific, when the carriers that are subject to measurements have equal indices, the user terminal decides the measurement gap to prioritize based on priorities determined in advance (for example, RSRP/RSRQ may be prioritized).

For example, in FIG. 11, the measurement gap to measure the RSSI of carrier F2 and the measurement gap to measure the RSRP/RSRQ of carrier F3 collide with each other, the user terminal prioritizes the RSSI measurement gap, in which carrier F2 of the lower carrier index is subject to measurements. In this case, the user terminal measures the RSSI of carrier F2 in this RSSI measurement gap, and stops the measurements in the RSRP/RSRQ measurement gap for carrier F3.

Also, when, in FIG. 11, the RSSI measurement gap and the RSRP/RSRQ measurement gap in the same carrier F2 collide with each other, the user terminal prioritizes the RSRP/RSRQ measurement gap. In this case, based on predetermined priorities, the user terminal measures the RSSI of carrier F2 in the RSSI measurement gap, and stops measuring the RSRP of carrier F2.

### Example 3.2

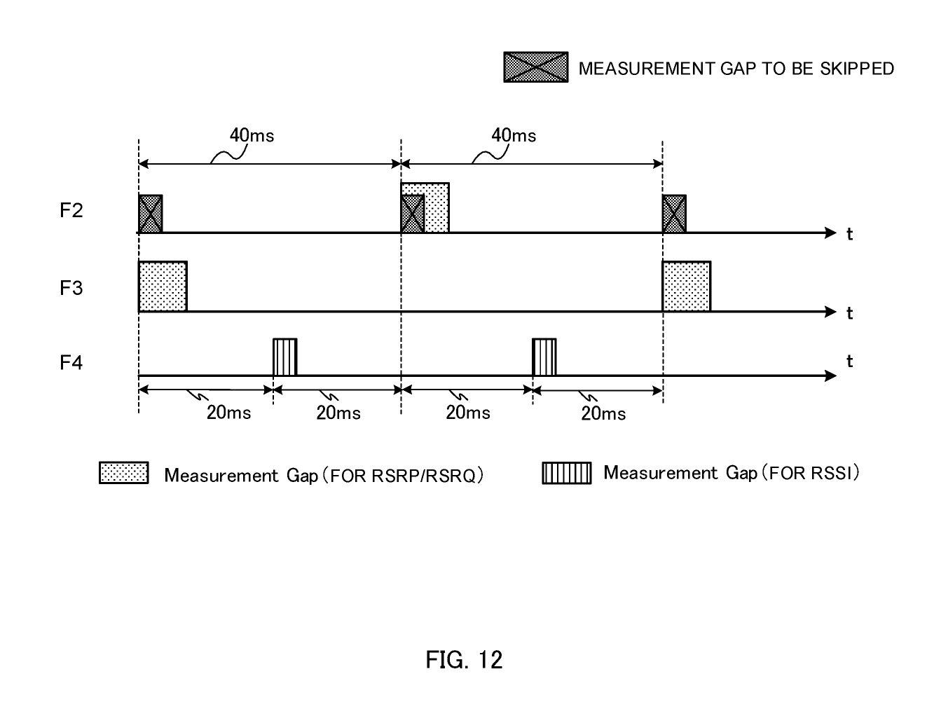

FIG. 12 is a diagram to show an example of inter-frequency measurement control according to example 3.2. In example 3.2, the user terminal may determine the measurement gap to prioritize based on priorities that are determined in advance, regardless of what indices the measurement-target carriers have. For example, the priority of RSRP may be configured higher than RSSI in advance. In this case, the user terminal prioritizes the measurements of RSRP/RSRQ in RSRP/RSRQ measurement gaps over the measurements of RSSI in RSSI measurement gaps.

For example, when, in FIG. 12, the measurement gap for measuring the RSSI of carrier F2 and the measurement gap for measuring the RSRP/RSRQ of carrier F3 collide with each other, the user terminal, unlike FIG. 11, prioritizes the measurement gap for the RSRP/RSRQ to be measured in carrier F3. In this case, the user terminal measures the RSRP/RSRQ of carrier F3 in this RSRP/RSRQ measurement gap, and stops the measurement in the RSSI measurement gap for carrier F2.

### Example 3.3

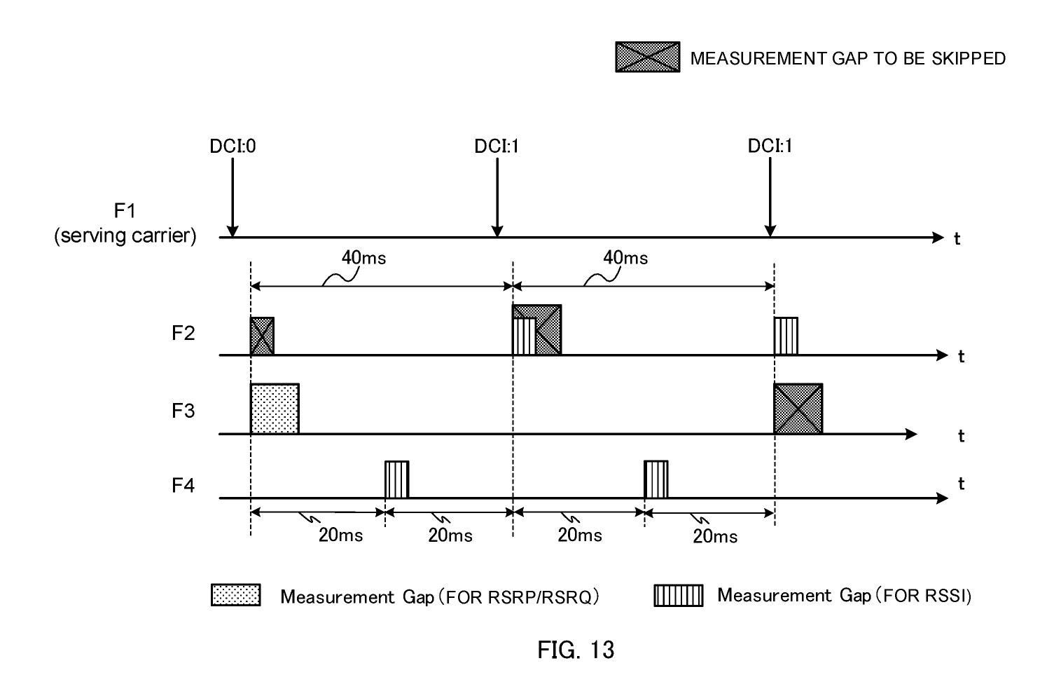

FIG. 13 is a diagram to show an example of inter-frequency measurement control according to example 3.3. According to the third example of control, the user terminal decides which measurement gap should be prioritized, based on priority information from the radio base station.

Here, the priority information is information that indicates which one of the RSRP/RSRQ measurement gap (that is, RSRP measurement) and the RSSI measurement gap (that is, RSSI measurement) is prioritized. For the priority information, existing downlink control information (DCI) bits may be re-used, or new bits may be set forth. For example, the priority information “1” may indicate prioritizing the RSRP/RSRQ measurement gap and the priority information “0” may indicate prioritizing the RSSI measurement gap, but this is by no means limiting.

For example, in FIG. 13, the user terminal receives DCI that includes the above priority information, in carrier F1 (serving carrier), in the subframe that is immediately before where the measurement gaps collide. As shown in FIG. 13, when the priority information that is received in the immediately preceding subframe shows “0,” the user terminal prioritizes the RSRP/RSRQ measurement gap. On the other hand, when the priority information that is received in the immediately preceding subframe shows “1,” the user terminal prioritizes the RSSI measurement gap.

Although, in FIG. 13, the radio base station transmits DCI including the above priority information in the subframe immediately before where the RSRP/RSRQ measurement gap and the RSSI measurement gap collide with each other, this is by no means limiting. The DCI to include priority information may be transmitted in the subframe that is a predetermined number of subframes before the measurement gaps that collide. Also, the DCI to include priority information may be transmitted in the subframe that is a predetermined number of subframes before a measurement gap that does not collide (for example, in FIG. 13, the measurement gap for measuring the RSSI of carrier F4).

Also, although, in FIG. 13, the priority information is transmitted by using the user terminal's serving carrier in an unlicensed band, this is by no means limiting. The scheduling information has only to be transmitted by using at least one of a licensed carrier and an unlicensed carrier.

According to example, even when an RSSI measurement gap and an RSRP/RSRQ measurement gap collide with each other, a user terminal still can adequately decide which measurement gap should be prioritized. Consequently, even when RSSI measurement gaps and RSRP/RSRQ measurement gaps are configured, inter-frequency measurements can be carried out adequately.

(Radio Communication System)

Now, the structure of the radio communication system according to the present embodiment will be described below. In this radio communication system, the radio communication methods according to the above-described embodiments are employed. Note that the radio communication methods of the above-described embodiments may be applied individually or may be applied in combination.

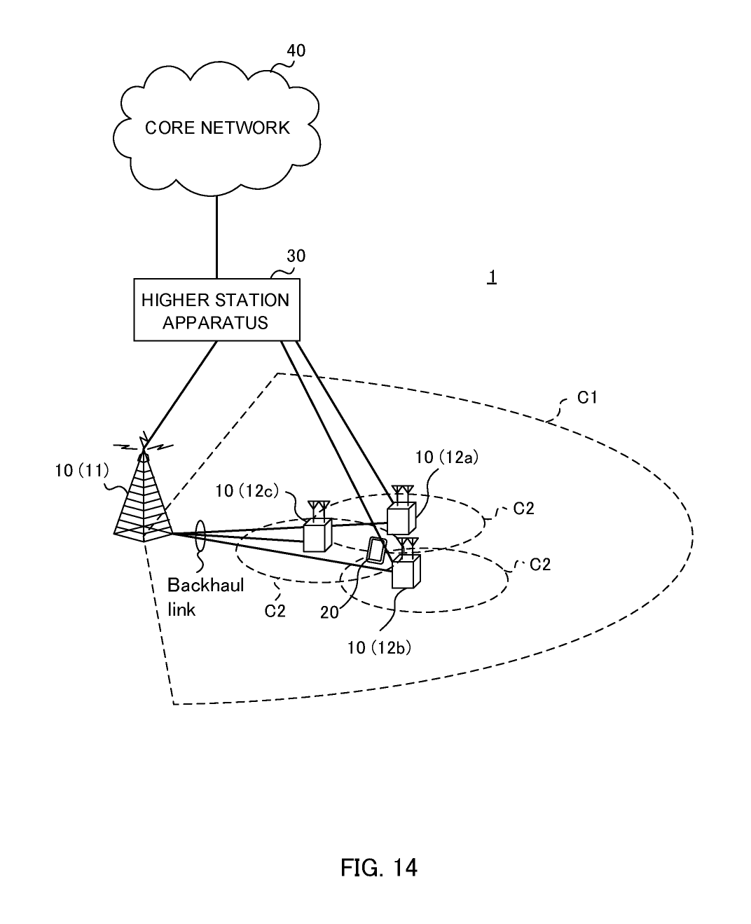

FIG. 14 is a diagram to show an example of a schematic structure of a radio communication system according to the present embodiment. The radio communication system 1 can adopt carrier aggregation (CA) and/or adopt dual connectivity (DC) to group a plurality of fundamental frequency blocks (component carriers) into one, where the LTE system bandwidth constitutes one unit. Also, the radio communication system 1 has a radio base station (for example, an LTE-U base station) that is capable of using unlicensed bands.

Note that the radio communication system 1 may be referred to as “SUPER 3G,” “LTE-A,” (LTE-Advanced), “IMT-Advanced,” “4G” (4th generation mobile communication system), “5G” (5th generation mobile communication system), “FRA” (Future Radio Access) and so on.

The radio communication system 1 shown in FIG. 14 includes a radio base station 11 that forms a macro cell C1, and radio base stations 12 (12a to 12c) that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed band and the small cells C2 are used in unlicensed bands (LTE-U). Also, a mode may be also possible in which part of the small cells is used in a licensed band and the rest of the small cells are used in unlicensed bands.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (for example, the downlink signal configuration) related to a radio base station 12 (which is, for example, an LTE-U base station) that uses an unlicensed band, from the radio base station 11 that uses a licensed band to the user terminals 20. Here, a structure may be employed in which, when CA is used between the licensed band and the unlicensed band, one of the radio base stations (for example, the radio base station 11) controls the scheduling of the licensed band cells and the unlicensed band cells.

Note that it is equally possible to use a structure in which a user terminal 20 connects with a radio base station 12, without connecting with the radio base station 11. For example, it is possible to use a structure in which a radio base station 12 that uses an unlicensed band connects with the user terminals 20 in stand-alone. In this case, the radio base station 12 controls the scheduling of unlicensed band cells.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the configuration of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as “radio base stations 10,” unless specified otherwise. Also, it is preferable to configure radio base stations 10 that use the same unlicensed band on a shared basis to be synchronized in time.

The user terminals 20 are terminals to support various communication schemes such as LTE, LTE-A and so on, and may be either mobile communication terminals or stationary communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. The PDSCH may be referred to as a “down link data channel.” User data, higher layer control information and predetermined SIBs (System Information Blocks) are communicated in the PDSCH. Also, MIBs (Master Information Blocks) are communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. A CFI (Control Format Indicator), which indicates the number of OFDM symbols to use for the PDCCH, is communicated by the PCFICH. HARQ delivery acknowledgement signals (ACKs/NACKs) in response to the PUSCH are communicated by the PHICH. The EPDCCH is frequency-division-multiplexed with the PDSCH and used to communicate DCI and so on, like the PDCCH. An enhanced PCFICH is used to communicate common control information for unlicensed band cells, in addition to the CFI.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. The PUSCH may be referred to as an uplink data channel. User data and higher layer control information are communicated by the PUSCH. Also, downlink radio quality information (CQI: Channel Quality Indicator), delivery acknowledgment information (ACKs/NACKs) and so on are communicated by the PUCCH. By means of the PRACH, random access preambles for establishing connections with cells are communicated.

In the radio communication systems 1, cell-specific reference signals (CRSs), channel state information reference signals (CSI-RSs), demodulation reference signal (DMRSs), detection/measurement reference signals (DRSs (Discovery Reference Signals) and so on are communicated as downlink reference signals. Also, in the radio communication system 1, measurement reference signals (SRSs: Sounding Reference Signals), demodulation reference signals (DMRSs) and so on are communicated as uplink reference signals. Note that, the DMRSs may be referred to as user terminal-specific reference signals (UE-specific Reference Signals). Also, the reference signals to be communicated are by no means limited to these.

(Radio Base Station)

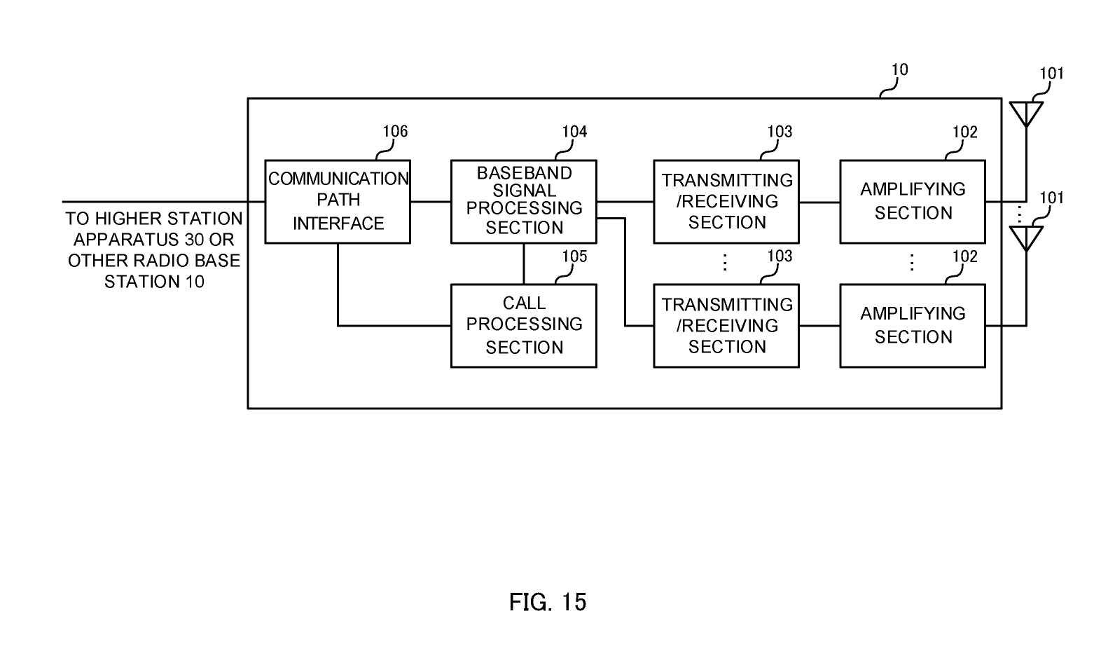

FIG. 15 is a diagram to show an example of an overall structure of a radio base station according to the present embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are pre-coded and output from the baseband signal processing section 104 on a per antenna basis are converted into a radio frequency band in the transmitting/receiving sections 103, and then transmitted. The radio frequency signals subjected to frequency conversion in the transmitting/receiving sections 103 are amplified in the amplifying sections 102, and transmitted from the transmitting/receiving antennas 101.

The transmitting/receiving sections 103 are capable of transmitting/receiving uplink/downlink signals in unlicensed bands. Note that the transmitting/receiving sections 103 may be capable of transmitting/receiving uplink/downlink signals in licensed bands as well. The transmitting/receiving sections 103 can be constituted by transmitters/receivers, transmitting/receiving circuits or transmitting/receiving devices that can be described based on common understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (for example, an interface in compliance with the CPRI (Common Public Radio Interface)m such as optical fiber, the X2 interface).

Note that the transmitting/receiving sections 103 transmit downlink signals to the user terminal 20 by using at least an unlicensed band. For example, the transmitting/receiving sections 103 transmit a DRS that includes at least one of a PSS, an SSS, a CRS and a CSI-RS, in an unlicensed band, in the DMTC duration configured in the user terminal 20. Also, the transmitting/receiving sections 103 transmit information about the scheduling of the PDSCH (downlink shared channel) or the PUSCH (uplink shared channel) (hereinafter referred to as “PDSCH/PUSCH”) for the user terminal 20 via the PDCCH/EPDCCH.

Also, the transmitting/receiving sections 103 receive uplink signals from the user terminal 20 by using at least an unlicensed band. The transmitting/receiving sections 103 may receive, from the user terminal 20, the results of RRM measurements and/or CSI measurements, via a licensed band and/or an unlicensed band. Also, the transmitting/receiving sections 103 may receive, from the user terminal 20, a measurement report that includes at least one of RSSI, RSRP and RSRQ that has been measured in inter-frequency measurements.

Also, by using higher layer signaling, the transmitting/receiving sections 103 transmit first pattern information, which represents the MGL and MGRP for configuring RSSI measurement gaps (first gap period), and second pattern information, which represents the MGL and MGRP for configuring RSRP/RSRQ measurement gaps (second gap period). As mentioned earlier, although the first and second pattern information refers to, for example, gap pattern IDs, gap offsets that correspond to gap patterns and so on, any information may be used as long as the information represents MGL and MGRP.

Also, the transmitting/receiving sections 103 may transmit, via the PDCCH and/or the EPDCCH (downlink control channel) (hereinafter referred to as “PDCCH/EPDCCH”), command information that indicates whether or not RSSI measurement gaps or RSRP/RSRQ measurement gaps are valid (example 2.1). Also, the transmitting/receiving sections 103 may transmit, via higher layer signaling, carrier-specific control information that indicates the measurement periodicity for each carrier (example 2.3). Also, the transmitting/receiving sections 103 may transmit, via the PDCCH/EPDCCH, priority information that indicates the priority of each gap period (example 3.3).

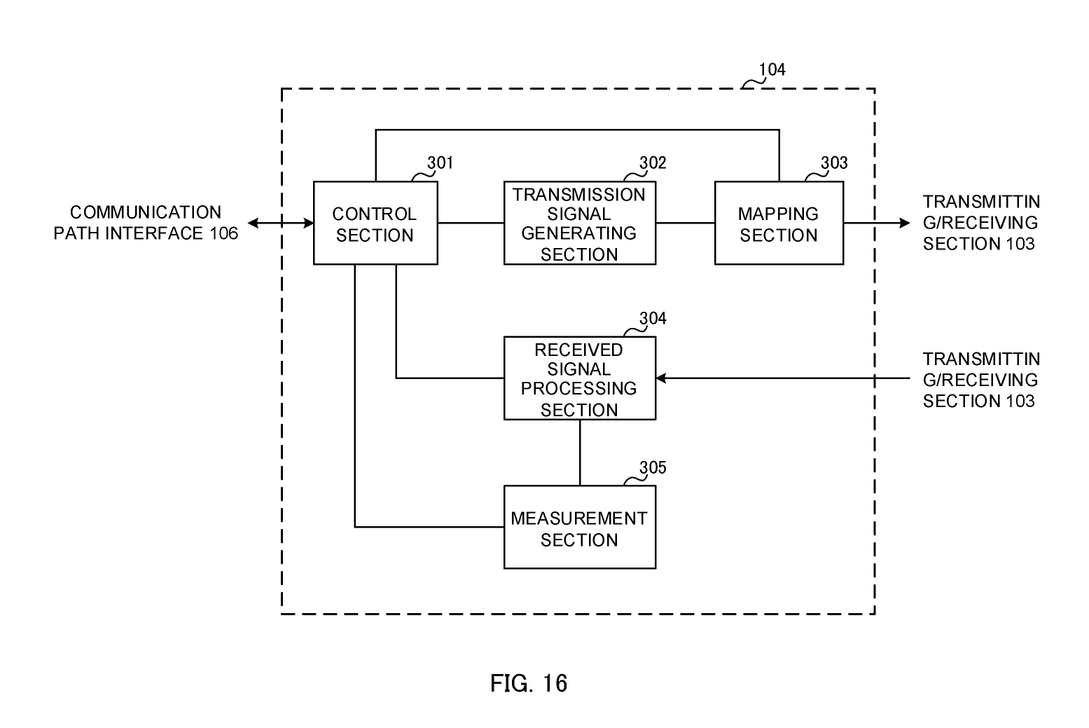

FIG. 16 is a diagram to show an example of a functional structure of a radio base station according to one embodiment of the present invention. Note that, although FIG. 16 primarily shows functional blocks that pertain to characteristic parts of the present embodiment, the radio base station 10 has other functional blocks that are necessary for radio communication as well. As shown in FIG. 16, the baseband signal processing section 104 has a control section (scheduler) 301, a transmission signal generating section (generating section) 302, a mapping section 303, a received signal processing section 304 and a measurement section 305.

The control section (scheduler) 301 controls the whole of the radio base station 10. Note that, when a licensed band and an unlicensed band are scheduled with one control section (scheduler) 301, the control section 301 controls communication in the licensed band cells and the unlicensed band cells. For the control section 301, a controller, a control circuit or a control device that can be described based on common understanding of the technical field to which the present invention pertains can be used.

The control section 301, for example, controls the generation of signals in the transmission signal generating section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling (for example, resource allocation) of system information, downlink data signals that are transmitted in the PDSCH and downlink control signals (common control information and dedicated control information) that are communicated in the PDCCH and/or the EPDCCH. Also, the control section 301 controls the scheduling of synchronization signals (PSS (Primary Synchronization Signal) and/or SSS (Secondary Synchronization Signal)) and downlink reference signals such as the CRS, the CSI-RS, the DMRS and the DRS. Also, the control section 301 controls the transmission signal generating section 302 and the transmitting/receiving section 103 to generate and transmit PDSCH/PUSCH scheduling information (DL assignments, UL grants, etc.).

Also, the control section 301 controls the scheduling of uplink data signals transmitted in the PUSCH, uplink control signals transmitted in the PUCCH and/or the PUSCH (for example, delivery acknowledgement signals (HARQ-ACKs)), random access preambles transmitted in the PRACH, uplink reference signals and so on.

The control section 301 controls the transmission of downlink signals in the transmission signal generating section 302 and the mapping section 303 in accordance with the results of LBT acquired in the measurement section 305. To be more specific, the control section 301 controls the generation, mapping and transmission of each signal that is included in the DRS (LA DRS) so that the DRS is transmitted in an unlicensed band.

Also, the control section 301 controls, in the user terminal 20, the inter-frequency RSSI measurements in RSSI measurement gaps, and the inter-frequency RSRP/RSRQ measurements in RSRP/RSRQ measurement gaps. To be more specific, the control section 301 determines the gap patterns of RSSI measurement gaps and RSRP/RSRQ measurement gaps. The control section 301 controls the transmission signal generating section 302 to generate first and second pattern information that indicate the determined gap patterns (MGL, MGRP, etc.).

For example, the control section 301 may decide on gap pattern 2 of FIG. 3 (the gap pattern ID or the gap offset to represent gap pattern 2) for RSSI measurement gaps, and decide on gap pattern 0 or 1 of FIG. 3 (the gap pattern ID or the gap offset to represent gap pattern 0 or 1) for RSRP/RSRQ measurement gaps (example 1). Note that RSSI measurement gaps are by no means limited to gap pattern 2, as long as RSSI measurement gaps are provided in a shorter MGL and/or MGRP than RSRP/RSRQ measurement gaps.

Also, the control section 301 determines whether or not an RSSI measurement gap or an RSRP/RSRQ measurement gap is valid, based on the situation of PDSCH/PUSCH scheduling. The control section 301 may control the transmission signal generating section 302 and the transmitting/receiving sections 103 to generate command information that represents the determine result and transmit this command information in the subframe that is a predetermined number of subframes before the measurement gap (example 2.1).

Also, the control section 301 may determine a different RSSI measurement periodicity for each carrier in RSSI measurement gaps, and/or determine a different RSRP/RSRQ measurement periodicity for each carrier in RSRP/RSRQ measurement gaps (example 2.3). Note that the control section 301 may determine each carrier's measurement periodicity so that at least one of the measurement gaps is skipped (FIG. 9). By this means, it is possible to achieve PDSCH/PUSCH scheduling opportunities. Also, the control section 301 may control the transmission signal generating section 302 and the transmitting/receiving sections 103 to generate and transmit carrier-specific control information that represents the determine results.

Also, if RSSI measurement gaps and RSRP/RSRQ measurement gaps collide with each other, the control section 301 may determine the priority of each measurement gap (example 3.3). The control section 301 may control the transmission signal generating section 302 and the transmitting/receiving sections 103 to generate and transmit priority information that represents the determined results.

The transmission signal generating section 302 generates downlink signals (downlink control signals, downlink data signals, downlink reference signals and so on) based on commands from the control section 301, and outputs these signals to the mapping section 303. The transmission signal generating section 302 can be constituted by a signal generator, a signal generating circuit or a signal generating device that can be described based on common understanding of the technical field to which the present invention pertains.

The transmission signal generating sections 302 generate PDSCH/PUSCH scheduling information based on, for example, commands from the control section 301. Also, the PDSCH is subjected to a coding process and a modulation process by using coding rates, modulation schemes and so on, determined based on the result of CSI measurements in each user terminal 20 and so on. Also, the transmission signal generating section 302 includes a DRS that includes at least one of a PSS, an SSS, a CRS and a CSI-RS.

Also, based on commands from the control section 301, the transmission signal generating section 302 may generate downlink control information that includes at least one of command information that indicates whether or not RSSI measurement gaps or RSRP/RSRQ measurement gaps are valid (example 2.1), priority information that indicates the priority of each gap period (example 3.3), and PDSCH/PUSCH scheduling information. Also, as higher layer control information, the transmission signal generating section 302 may generate first pattern information, second pattern information, carrier-specific control information that indicates each carrier's measurement periodicity (example 2.3) and so on.

The mapping section 303 maps the downlink signals generated in the transmission signal generating section 302 to predetermined radio resources based on commands from the control section 301, and outputs these to the transmitting/receiving sections 103. The mapping section 303 can be constituted by a mapper, a mapping circuit or a mapping device that can be described based on common understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). The received signal processing section 304 can be constituted by a signal processor, a signal processing circuit or a signal processing device that can be described based on common understanding of the technical field to which the present invention pertains.

The received signal processing section 304 outputs the decoded information acquired through the receiving processes to the control section 301. For example, when a PUCCH to contain an HARQ-ACK is received, the received signal processing section 304 outputs this HARQ-ACK to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or a measurement device that can be described based on common understanding of the technical field to which the present invention pertains.

The measurement section 305 executes LBT in a carrier where LBT is configured (for example, an unlicensed band) based on commands from the control section 301, and outputs the results of LBT (for example, judgments as to whether the channel state is idle or busy) to the control section 301.

Also, the measurement section 305 may measure, for example, RSSI, RSRP, RSRQ, channel states and so on. The measurement results may be output to the control section 301.

(User Terminal)

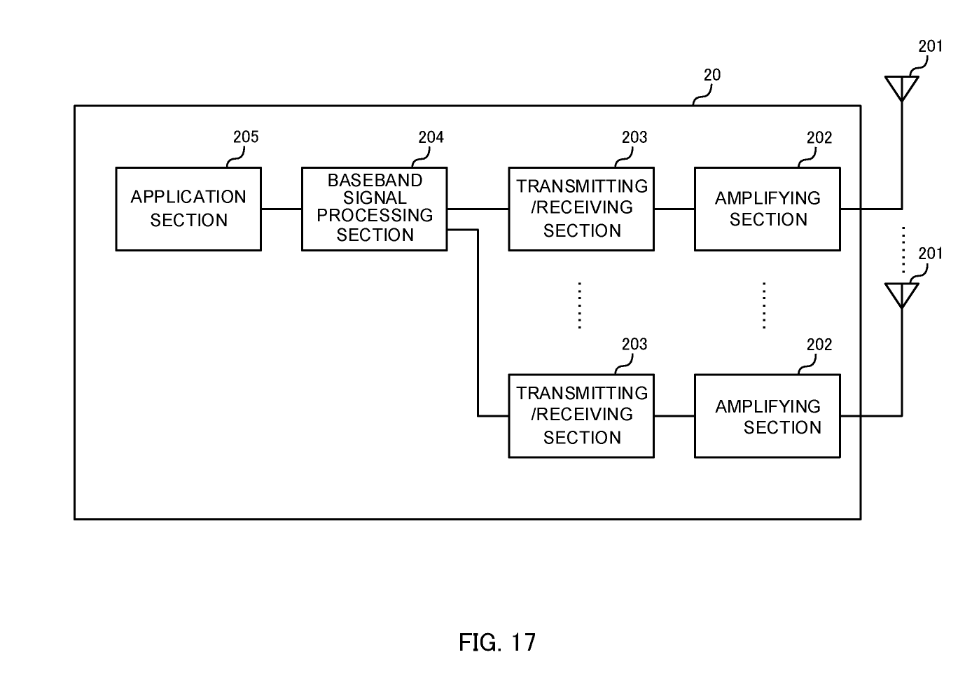

FIG. 17 is a diagram to show an example of an overall structure of a user terminal according to the present embodiment. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204. The transmitting/receiving sections 203 are capable of transmitting/receiving uplink/downlink signals in unlicensed bands. Note that the transmitting/receiving sections 203 may be capable of transmitting/receiving uplink/downlink signals in licensed bands as well.

The transmitting/receiving sections 203 can be constituted by transmitters/receivers, transmitting/receiving circuits or transmitting/receiving devices that can be described based on common understanding of the technical field to which the present invention pertains. Note that a transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 receive downlink signals transmitted from the radio base station 10, by using at least an unlicensed band. For example, the transmitting/receiving sections 203 receive a DRS, which includes at least one of a PSS, an SSS, a CRS and a CSI-RS, in an unlicensed band, in a DMTC duration that is configured by the radio base station 10.

Also, the transmitting/receiving sections 203 transmit uplink signals to the radio base station 10 by using at least an unlicensed band. For example, the transmitting/receiving sections 203 may transmit DRS RRM measurement results and/or CSI measurement results (for example, CSI feedback) in a licensed band and/or an unlicensed band. Also, the transmitting/receiving section 203 may transmit a measurement report that includes at least one of RSSI, RSRP and RSRQ that has been measured in inter-frequency measurements, to the radio base station 10.

Also, the transmitting/receiving sections 203 receive the above-described first pattern information and second pattern information via higher layer signaling. Furthermore, the transmitting/receiving sections 203 may receive information about PDSCH/PUSCH scheduling for the user terminal 20 via the PDCCH/EPDCCH.

Also, the transmitting/receiving sections 203 may receive command information that indicates whether or not RSSI measurement gaps or RSRP/RSRQ measurement gaps are valid, via the PDCCH/EPDCCH (example 2.1). Furthermore, the transmitting/receiving sections 203 may receive, via higher layer signaling, carrier-specific control information that indicates the measurement periodicity for each carrier (example 2.3). Also, the transmitting/receiving section 203 may receive priority information, which indicates the priority of each gap period, via the PDCCH/EPDCCH (example 3.3).

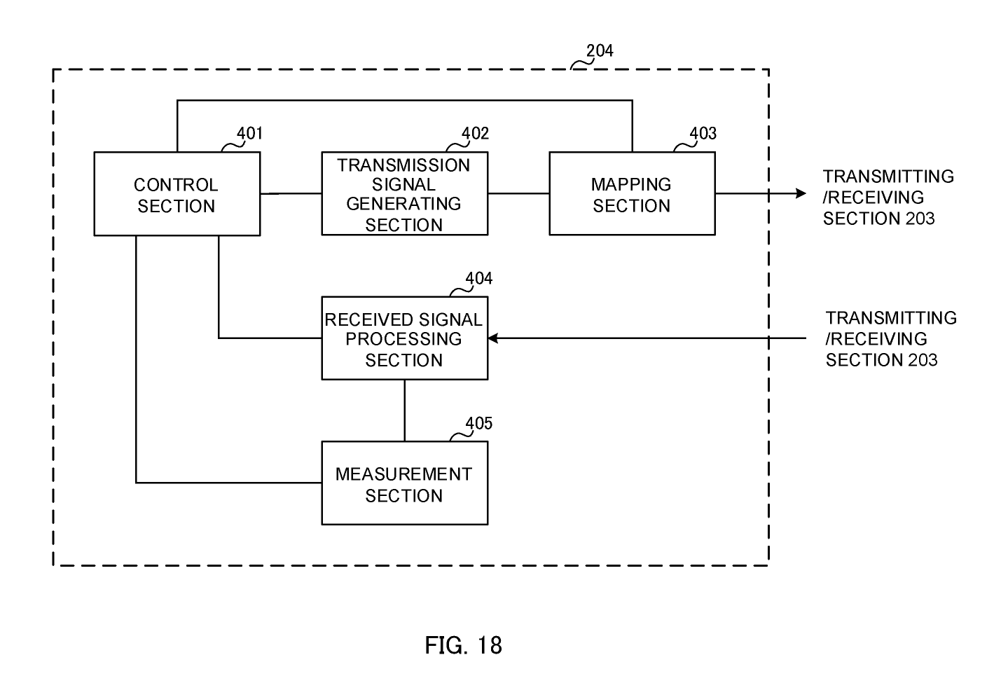

FIG. 18 is a diagram to show an example of a functional structure of a user terminal according to one embodiment of the present invention. Note that, although FIG. 18 primarily shows functional blocks that pertain to characteristic parts of the present embodiment, the user terminal 20 has other functional blocks that are necessary for radio communication as well. As shown in FIG. 18, the baseband signal processing section 204 provided in the user terminal 20 at least has a control section 401, a transmission signal generating section 402, a mapping section 403, a received signal processing section 404 and a measurement section 405.

The control section 401 controls the whole of the user terminal 20. The control section 401 can be constituted by a controller, a control circuit or a control device that can be described based on common understanding of the technical field to which the present invention pertains.

The control section 401, for example, controls the generation of signals in the transmission signal generating section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on.

The control section 401 controls the received signal processing section 404 and the measurement section 405 to carry out RRM measurements and/or CSI measurements, cell search and so on in an unlicensed band. Note that RRM measurements may be performed by using LAA DRSs. Also, CSI measurements may be carried out by using LAA DRSs, or by using CSI-RSs/IMs. Furthermore, the control section 401 may control the transmission signal generating section 402 and the mapping section 403 to transmit uplink signals based on LBT results acquired in the measurement section 405.

To be more specific, the control section 401 configures RSSI measurement gaps based on the above-described first pattern information, and configures RSRP/RSRQ measurement gaps based on the above-described second pattern information. The control section 401 controls the inter-frequency RSSI measurements in these RSSI measurement gaps and the inter-frequency RSRP/RSRQ measurements in the RSRP/RSRQ measurement gaps.

For example, the control section 401 may command the measurement section 405 to stop (skip) the measurements in the RSSI measurement gaps or the measurements in the RSRP/RSRQ measurement gaps based on the command information that indicates whether or not the RSSI measurement gaps or the RSRP/RSRQ measurement gaps are valid (example 2.1).

Furthermore, when PDSCH/PUSCH scheduling information is received within a predetermined period before an RSSI measurement gap or an RSRP/RSRQ measurement gap, the control section 401 may command the measurement section 405 to stop (skip) the measurement in the RSSI measurement gap or the measurement in the RSRP/RSRQ measurement gap (example 2.2).

Also, the control section 401 determines the carrier for measuring RSSI in each RSSI measurement gap. Also, the control section 401 determines the carrier for measuring RSRP/RSRQ in each RSRP/RSRQ measurement gap. These carriers may be reported from the radio base station 10 via higher layer signaling.

Furthermore, the control section 401 may command the measurement section 405 to measure RSSI, in RSSI measurement gaps, in a different measurement periodicity per carrier (example 2.3). Also, the control section 401 may command the measurement section 405 to measure RSRP, in RSRP/RSRQ measurement gaps, in a different measurement periodicity per carrier (example 2.3). Each carrier's measurement periodicity may be reported from the radio base station 10 via higher layer signaling.

Also, when an RSSI measurement gap and an RSRP/RSRQ measurement gap overlap, the control section 401 may command the measurement section 405 to stop (skip) the measurement in the RSSI measurement gap or the measurement in the RSRP/RSRQ measurement gap, based on the indices of the measurement-target carriers (example 3.1). For example, the control section 401 may prioritize the measurement gap to measure the carrier of the lower index value. Also, if the carriers have equal index values, the control section 401 may prioritize the measurement gap in which the predetermined priority is higher (for example, the RSRP/RSRQ measurement gap).

Also, when an RSSI measurement gap and an RSRP/RSRQ measurement gap overlap, the control section 401 may command the measurement section 405 to stop (skip) the measurement in the RSSI measurement gap or the measurement in the RSRP/RSRQ measurement gap based on priorities that are determined in advance (example 3.2).

Furthermore, when an RSSI measurement gap and an RSRP/RSRQ measurement gap overlap, the control section 401 may command the measurement section 405 to stop (skip) the measurement in the RSSI measurement gap or the measurement in the RSRP/RSRQ measurement gap based on the priorities indicated by priority information that is provided from the radio base station 10 (example 3.3).

The transmission signal generating section 402 generates uplink signals (uplink control signals, uplink data signals, uplink reference signals and so on) based on commands from the control section 401, and outputs these signals to the mapping section 403. The transmission signal generating section 402 can be constituted by a signal generator, a signal generating circuit or a signal generating device that can be described based on common understanding of the technical field to which the present invention pertains.

For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

The mapping section 403 maps the uplink signals generated in the transmission signal generating section 402 to radio resources based on commands from the control section 401, and output the result to the transmitting/receiving sections 203. The mapping section 403 can be constituted by a mapper, a mapping circuit or a mapping device that can be described based on common understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains. Also, the received signal processing section 404 can constitute the receiving section according to the present invention.

The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. The measurement section 405 can be constituted by a measurer, a measurement circuit or a measurement device that can be described based on common understanding of the technical field to which the present invention pertains. The control section 401 and the measurement section 405 constitute the measurement section of the present invention.

The measurement section 405 may execute LBT in a carrier where LBT is configured (for example, an unlicensed band) based on commands from the control section 401. The measurement section 405 may output the results of LBT (for example, judgments as to whether the channel state is idle or busy) to the control section 401. Also, the measurement section 405 may carry out RRM measurements and CSI measurements, and output the measurement results to the control section 401.

To be more specific, based on commands from the control section 401, the measurement section 405 carries out inter-frequency RSSI measurements in RSSI measurement gaps that are configured based on the above-described first pattern information, and carries out inter-frequency RSRP/RSRQ measurements in RSRP/RSRQ measurement gaps that are configured based on the above-described second patter n information. The measurement results are output to the control section 401, and a measurement report to include these measurement results may be generated in the transmission signal generating section 402.

Also, following commands from the control section 401, the measurement section 405 stops (skips) the measurements in RSSI measurement gaps or the measurements in RSRP/RSRQ measurement gaps.

<Hardware Structure>

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be implemented with one physically-integrated device, or may be implemented by connecting two physically-separate devices via radio or wire and using these multiple devices.

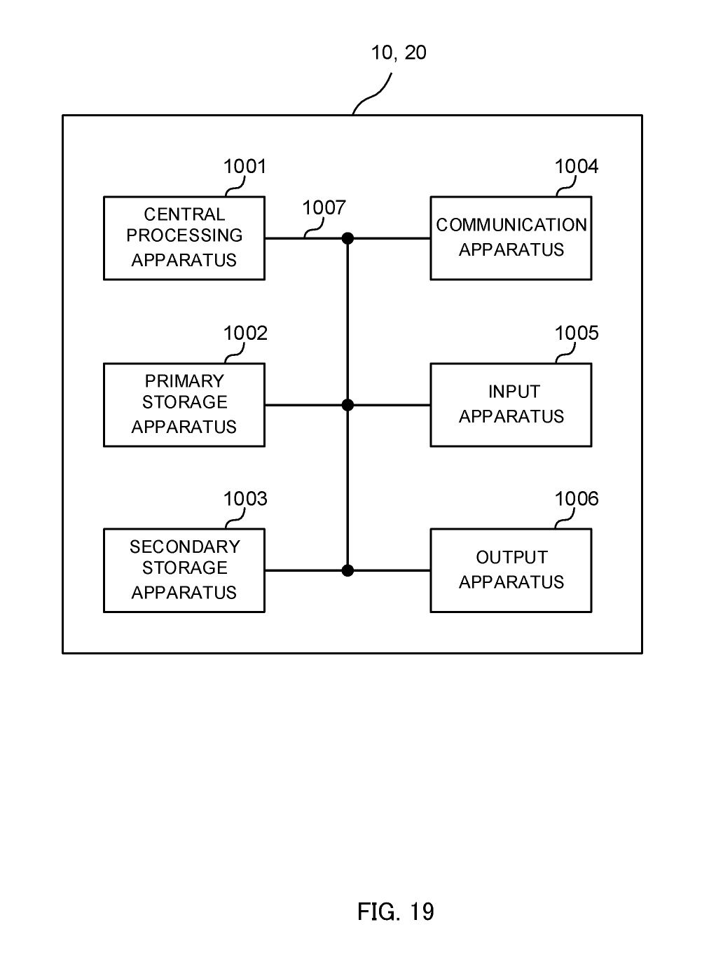

That is, a radio base station, a user terminal and so on according to an embodiment of the present invention may function as a computer that executes the processes of the radio communication method of the present invention. FIG. 19 is a diagram to show an example hardware structure of a radio base station and a user terminal according to an embodiment of the present invention. Physically, a radio base station 10 and a user terminal 20, which have been described above, may be formed as a computer apparatus that includes a central processing apparatus (processor) 1001, a primary storage apparatus (memory) 1002, a secondary storage apparatus 1003, a communication apparatus 1004, an input apparatus 1005, an output apparatus 1006 and a bus 1007. Note that, in the following description, the word “apparatus” may be replaced by “circuit,” “device,” “unit” and so on.

Each function of the radio base station 10 and user terminal 20 is implemented by reading predetermined software (programs) on hardware such as the central processing apparatus 1001, the primary storage apparatus 1002 and so on, and controlling the calculations in the central processing apparatus 1001, the communication in the communication apparatus 1004, and the reading and/or writing of data in the primary storage apparatus 1002 and the secondary storage apparatus 1003.

The central processing apparatus 1001 may control the whole computer by, for example, running an operating system. The central processing apparatus 1001 may be formed with a processor (CPU: Central Processing Unit) that includes a control apparatus, a calculation apparatus, a register, interfaces with peripheral apparatus, and so on. For example, the above-described baseband signal process section 104 (204), call processing section 105 and so on may be implemented by the central processing apparatus 1001.

Also, the central processing apparatus 1001 reads programs, software modules, data and so on from the secondary storage apparatus 1003 and/or the communication apparatus 1004, into the primary storage apparatus 1002, and executes various processes in accordance with these. As for the programs, programs to allow the computer to execute at least part of the operations of the above-described embodiment may be used. For example, the control section 401 of the user terminal 20 may be stored in the primary storage apparatus 1002 and implemented by a control program that runs on the central processing apparatus 1001, and other functional blocks may be implemented likewise.

The primary storage apparatus (memory) 1002 is a computer-readable recording medium, and may be constituted by, for example, at least one of a ROM (Read Only Memory), an EPROM (Erasable Programmable ROM), a RAM (Random Access Memory) and so on. The secondary storage apparatus 1003 is a computer-readable recording medium, and may be constituted by, for example, at least one of a flexible disk, an opto-magnetic disk, a CD-ROM (Compact Disc ROM), a hard disk drive and so on.

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, etc.). The output apparatus 1006 is an output device for allowing sending output to the outside (for example, a display, a speaker, etc.). Note that the input apparatus 1005 and the output apparatus 1006 may be provided in an integrated structure (for example, a touch panel).

Also, the apparatuses, including the central processing apparatus 1001, the primary storage apparatus 1002 and so on, may be connected via a bus 1007 to communicate information with each other. The bus 1007 may be formed with a single bus, or may be formed with buses that vary between the apparatuses. Note that the hardware structure of the radio base station 10 and the user terminal 20 may be designed to include one or more of each apparatus shown in the drawings, or may be designed not to include part of the apparatuses.

For example, the radio base station 10 and the user terminal 20 may be structured to include hardware such as an ASIC (Application-Specific Integrated Circuit), a PLD (Programmable Logic Device), an FPGA (Field Programmable Gate Array) and so on, and part or all of the functional blocks may be implemented by the hardware.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “cells,” “frequency carriers,” “carrier frequencies” and so on.

Also, the information and parameters described in this description may be represented in absolute values or in relative values with respect to a predetermined value, or may be represented by using other equivalent pieces of information. For example, radio resources may be specified by predetermined indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

Also, software and commands may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation and microwaves), these wired technologies and/or wireless technologies are also included in the definition of communication media.

The examples/embodiments illustrated in this description may be used individually or in combinations, and the mode of use may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the examples/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, broadcast information (MIBs (Master Information Blocks) and SIBs (System Information Blocks)) and MAC (Medium Access Control) signaling and so on), other signals or combinations of these. Also, RRC signaling may be referred to as “RRC messages,” and can be, for example, an RRC connection setup message, RRC connection reconfiguration message, and so on.

The examples/embodiments illustrated in this description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the examples/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-218001, filed on Nov. 5, 2015, including the specification, drawings and abstract, is incorporated herein by reference in its entirety.

1. A user terminal comprising:
a receiving section that receives first pattern information, which indicates a time length and a periodicity of a first gap period, and second pattern information, which indicates a time length and a periodicity of a second gap period; and
a measurement section that measures inter-frequency received signal intensity in the first gap period that is configured based on the first pattern information, and measures inter-frequency reference signal received power and/or reference signal received quality in the second gap period that is configured based on the second pattern information.

2. The user terminal according to claim 1, wherein the time length and/or the periodicity represented by the first pattern information are shorter than the time length and/or the periodicity represented by the second pattern information.

3. The user terminal according to claim 1, wherein:
the receiving section receives command information that indicates whether the first gap period or the second gap period is valid; and
the measurement section stops the measurement of the received signal intensity in the first gap period or the measurement of the reference signal received power and/or the reference signal received quality in the second gap period based on the command information.

4. The user terminal according to claim 1, wherein:
the receiving section receives information about scheduling of a downlink shared channel or an uplink shared channel for the user terminal; and
when the scheduling information is received within a predetermined period before the first gap period or the second gap period, the measurement section stops the measurement of the received signal intensity in the first gap period or the measurement of the reference signal received power and/or the reference signal received quality in the second gap period.

5. The user terminal according to claim 1, wherein the measurement section measures the received signal intensity of each carrier, in the first gap period, in a different measurement periodicity per carrier, and/or measures the reference signal received power and/or the reference signal received quality of each carrier, in the second gap period, in a different measurement periodicity per carrier.

6. The user terminal according to claim 1, wherein, when the first gap period and the second gap period overlap, the measurement section stops the measurement of the received signal intensity in the first gap period or the measurement of the reference signal received power and/or the reference signal received quality in the second gap period, based on indices of measurement-target carriers.

7. The user terminal according to claim 1, wherein, when the first gap period and the second gap period overlap, the measurement section stops the measurement of the received signal intensity in the first gap period or the measurement of the reference signal received power and/or the reference signal received quality in the second gap period, based on priorities that are determined in advance.

8. The user terminal according to claim 1, wherein;
the receiving section receives priority information, which indicates the priorities of the gap periods; and
the measurement section stops the measurement of the received signal intensity in the first gap period or the measurement of the reference signal received power and/or the reference signal received quality in the second gap period, based on the priorities.

9. A radio base station comprising:
a transmission section that transmits first pattern information, which indicates a time length and a periodicity of a first gap period, and second pattern information, which indicates a time length and a periodicity of a second gap period; and
a receiving section that receives a measurement report, in which received signal intensity, which is measured in inter-frequency measurements in the first gap period that is configured based on the first pattern information, and/or reference signal received power and/or reference signal received quality, which are measured in inter-frequency measurements in the second gap period that is configured based on the second pattern information, are included.

10. A radio communication method between a radio base station and a user terminal, the radio communication method comprising, in the user terminal, the steps of:
receiving first pattern information, which indicates a time length and a periodicity of a first gap period, and second pattern information, which indicates a time length and a periodicity of a second gap period; and
measuring inter-frequency received signal intensity in the first gap period that is configured based on the first pattern information, and measuring inter-frequency reference signal received power and/or reference signal received quality in the second gap period that is configured based on the second pattern information.

11. The user terminal according to claim 2, wherein:
the receiving section receives command information that indicates whether the first gap period or the second gap period is valid; and
the measurement section stops the measurement of the received signal intensity in the first gap period or the measurement of the reference signal received power and/or the reference signal received quality in the second gap period based on the command information.

12. The user terminal according to claim 2, wherein:
the receiving section receives information about scheduling of a downlink shared channel or an uplink shared channel for the user terminal; and
when the scheduling information is received within a predetermined period before the first gap period or the second gap period, the measurement section stops the measurement of the received signal intensity in the first gap period or the measurement of the reference signal received power and/or the reference signal received quality in the second gap period.

13. The user terminal according to claim 2, wherein the measurement section measures the received signal intensity of each carrier, in the first gap period, in a different measurement periodicity per carrier, and/or measures the reference signal received power and/or the reference signal received quality of each carrier, in the second gap period, in a different measurement periodicity per carrier.

14. The user terminal according to claim 2, wherein, when the first gap period and the second gap period overlap, the measurement section stops the measurement of the received signal intensity in the first gap period or the measurement of the reference signal received power and/or the reference signal received quality in the second gap period, based on indices of measurement-target carriers.

15. The user terminal according to claim 2, wherein, wherein, when the first gap period and the second gap period overlap, the measurement section stops the measurement of the received signal intensity in the first gap period or the measurement of the reference signal received power and/or the reference signal received quality in the second gap period, based on priorities that are determined in advance.

16. The user terminal according to claim 2, wherein;
the receiving section receives priority information, which indicates the priorities of the gap periods; and
the measurement section stops the measurement of the received signal intensity in the first gap period or the measurement of the reference signal received power and/or the reference signal received quality in the second gap period, based on the priorities.
